(19) United States
(12) Patent Application Publication
(10) Pub. No.: US 2026/0221407 A1
(43) Pub. Date: Jul. 30, 2026

(54) APPARATUS FOR INDUCTIVELY COUPLED PLASMA MASS SPECTROMETRY

(71) Applicant: Thermo Fisher Scientific (Bremen) GmbH, Bremen (DE)

(72) Inventor: Mikhail Belov, Bremen (DE)

(21) Appl. No.: 19/433,128

(22) Filed: Dec. 26, 2025

Related U.S. Application Data
(63) Continuation of application No. PCT/EP2024/068379, filed on Jun. 28, 2024.

(30) Foreign Application Priority Data
Jun. 30, 2023 (GB) 2310043.1

(51) Int. Cl. H01J 49/10; H01J 49/06

(52) U.S. Cl. CPC H01J 49/105; H01J 49/067

(57) ABSTRACT

A sampling interface enables the sampling of ions in a mass spectrometer for subsequent spectroscopic analysis. The sampling interface comprises: an inlet receiving a quantity of particles from an ion source, the quantity of particles including ions for spectroscopic analysis; a skimmer downstream of the inlet and comprising an aperture through which particles from the inlet pass; an extraction lens downstream of the skimmer and configured for extracting ions from the particles passed through the aperture at the skimmer; an adjustable voltage source applying a bias voltage to the extraction lens so as to generate an electric field in at least a region between the extraction lens and the skimmer; and a controller controlling the adjustable voltage source to apply a bias voltage to the extraction lens, in order to control the reduced electric field in the region immediately downstream of the skimmer.

### CROSS-REFERENCE TO RELATED APPLICATIONS

This application is a continuation of International Application No. PCT/EP2024/068379, filed Jun. 28, 2024 and claims priority to United Kingdom Application No. 202310043.1, filed Jun. 30, 2023, the disclosures of which are incorporated by reference in their entirety.

### FIELD OF THE DISCLOSURE

The present disclosure concerns improvements in or relating to mass spectrometry. More particularly, the invention relates to a sampling interface and a torch for generating a plasma, both for use within mass spectrometry apparatus. In a particular, examples of the present invention relate to apparatus and a method for inductively coupled plasma-mass spectrometry (ICP-MS).

### BACKGROUND TO THE DISCLOSURE

Mass spectrometers are specialist scientific instruments used for spectroscopic analysis of ionised or charged particles, in order to determine the elemental composition of a sample. Typically, ionised particles of a sample are passed through a mass analyser to separate the various charged particles into their mass-to-charge ratio, before being received at one or more detectors.

Prior to entry into the mass analyser, a sample must be converted into charged particles or ions and these charged particles or ions are then focused and directed through the mass spectrometer towards the mass analyser. One type of mass spectrometry uses an inductively coupled plasma to transform a sample into a plurality of particles, including charged particles or ions. The plasma may be generated, and introduction of the sample to the plasma may take place at, a plasma source (also known as a plasma torch). A stream of particles from the plasma is then passed through the mass spectrometer, in particular via a sampling interface. The sampling interface is a portion of a mass spectrometer arranged to enable the sampling of ions from a generated plasma and then subsequently to direct and focus those sampled ions towards a mass analyser for spectroscopic analysis. Common elements of a sampling apparatus include a sampling cone, a skimmer, and an extraction lens, each arranged in the direction of flow of the sample particles.

In a mass spectrometer incorporating a typical sampling interface and known conical torch, it is observed that degradation of instrument performance can occur over longer analysis cycles and especially for high-matrix samples (being solutions containing highly concentrated salts, acids, bases or other chemicals). In particular, degradation can be observed in the form of loss of analytical sensitivity (such as orders of magnitude of signal decay over an hour-long experiment) and reduced signal reproducibility (manifested in suppression of sample signals in the presence of ‘high-matrix’ constituents, compared to distinguishing ‘clean’ sample signals).

Such degradation in performance has been attributed to contamination downstream of the conical torch, including build-up of high-concentration matrix components at the sampling cone and skimmer. In particular, build-up has been observed around apertures (through which charged particles pass) of both the sampling cone and the skimmer, thereby reducing the diameter of the apertures. FIG. 1 shows an example of such a build up at a skimmer 10 with a nominal aperture diameter of 600 μm that has been contaminated by high concentration salts after a four-hour experiment. It can be seen that the skimmer aperture 20 now has a diameter reduced to around 420-450 μm by the build-up. This decrease in the skimmer aperture diameter in turn results in a pressure drop immediately downstream of the skimmer assembly, causing the type of overall performance degradation discussed above.

One known approach to mitigate a loss of analytical sensitivity is by de-tuning certain instrument parameters (for example, the pressure in the region between the sampling cone and the skimmer). Another option is to reduce the gas flow through the skimmer orifice, to decrease the amount of build-up. However, these techniques only partly solve a loss of sensitivity, but in addition can further diminish signal reproducibility.

U.S. Pat. No. 9,202,679 considers a sampling interface in which a bias voltage potential may be applied to a skimmer in order to control the kinetic energy of ions entering a collision region immediately behind the skimmer. However, applying a potential to the skimmer aperture fails to prevent the build-up of salt crystals on the skimmer surface. Moreover, only small voltages (for instance, of just a few volts) can be applied without disrupting the beam of particulates generated by the plasma. As such, further options to reduce the signal degradation would be desirable.

Modifications have also been made to the plasma torch. For instance, U.S. Pat. No. 10,212,798 describes a torch for generating an inductively coupled plasma comprising a torch tube concentric around a central, injector tube. An annular channel is defined between the torch tube and the injector tube, and the torch tube comprises tapered portions which open out towards each end such that the annular channel has a diameter which narrows in a central section. Gas can be passed through the annular channel in a helical formation for cooling of the torch, wherein the narrowing causes an acceleration of the gas flow. However, further enhancements to the torch would be beneficial.

Therefore, there is an objective to provide an improved apparatus and method for inductive coupled plasma mass spectrometry that addresses these problems.

### SUMMARY OF THE DISCLOSURE

In a first aspect, there is provided a sampling interface for use in mass spectroscopy apparatus, the sampling interface being arranged so as to enable the sampling of ions in a mass spectrometer for subsequent spectroscopic analysis, the sampling interface comprising:
an inlet for receiving a quantity of particles from an ion source, the quantity of particles including ions for spectroscopic analysis;
a skimmer arranged downstream of the inlet, the skimmer comprising an aperture through which particles from the inlet pass;
an extraction lens arranged downstream of the skimmer, the extraction lens being configured for extracting ions from the particles passed through the aperture at the skimmer;
an adjustable voltage source for applying a bias voltage to the extraction lens so as to generate an electric field in at least a region between the extraction lens and the skimmer; and
a controller configured to control the adjustable voltage source to apply a bias voltage to the extraction lens (that is, adjust the bias voltage at the extraction lens), in order to control the reduced electric field in the region immediately downstream of the skimmer.

In a second aspect, there is provided a method for sampling of ions in a mass spectrometer for subsequent spectroscopic analysis, the method comprising:
providing a sampling interface comprising:
   an inlet for receiving a quantity of particles from an ion source, the quantity of particles including ions for spectroscopic analysis;
   a skimmer arranged downstream of the inlet, the skimmer comprising an aperture through which particles from the inlet pass;
   an extraction lens downstream of the skimmer, the extraction lens being configured for extracting ions from the particles passed through the aperture at the skimmer;
   an adjustable voltage source for applying a bias voltage to the extraction lens so as to generate an electric field in at least a region between the extraction lens and the skimmer; and
applying, using the adjustable voltage source, a bias voltage to the extraction lens, in order to control the reduced electric field in the region immediately downstream of the skimmer.

In a third aspect, there is provided a torch for generating an inductively coupled plasma, the torch comprising:
a torch tube comprising a support end and an open end, wherein a portion of the open end defines a cavity for at least partially confining the inductively coupled plasma;
an injector tube comprising a bore extending through the injector tube between an injector inlet end for receiving a sample flow into the bore and an injector outlet end for conveying the sample flow out of the bore, wherein the injector tube is positioned to extend at least partially through the torch tube; and
wherein the diameter of the bore decreases between a first location and a second location, and the diameter of the bore is constant or decreases between the second location and a third location, the first location being closer to the injector inlet end than the third location, and the second location being between the first and third location in the direction of sample flow through the bore of the injector tube.

### BRIEF DESCRIPTION OF THE FIGURES

The disclosure may be put into practice in various ways, some of which will now be described by way of example only and with reference to the accompanying drawings in which:

FIG. 1 shows a photograph of build-up around an aperture through a skimmer of a sampling interface after a four-hour experiment with EPA solution (1000 parts-per-million (ppm));

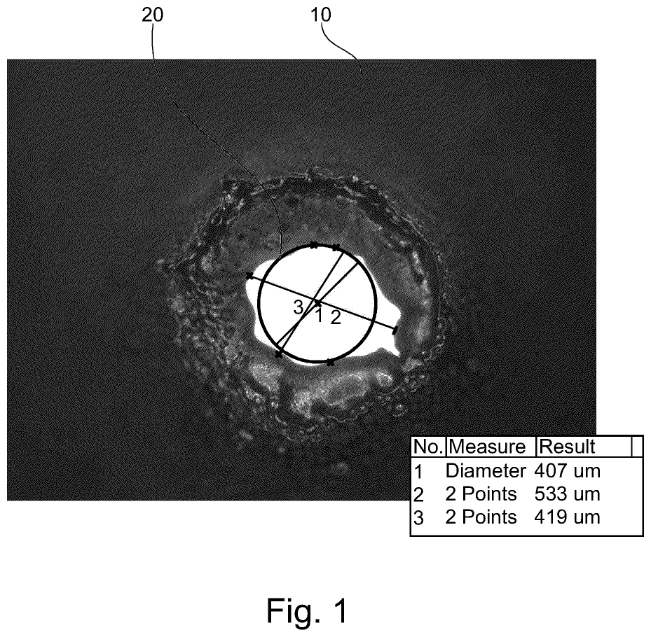

FIG. 2 shows a schematic diagram of a sampling interface and a torch arranged as part of an inductively coupled plasma-mass spectrometry assembly;

FIG. 3 shows a plot of the pressure in the region between the skimmer and the extraction lens as a function of time, together with a plot of a bias voltage applied to the extraction lens over the same time period;

FIG. 4 shows views of the disclosed torch for generating an inductively coupled plasma: in particular, FIG. 4(a) shows a cross section through a radial plane of the torch, FIG. 4(b) shows a cross section through an axial plane of the torch, and FIG. 4(c) shows a perspective view of the torch;

FIG. 5 shows a perspective view through an axial plane of the torch with a load coil arrangement;

FIG. 6 shows a photographic representation of an inductively coupled plasma generated by an example of the disclosed torch;

FIG. 7 shows a plot of signal intensities over time to allow calculation of the temperature of the plasma generated at the torch;

FIG. 8 shows a plot of signal intensities over time in the analysis of 1 ppb calibration solution using an example of the disclosed torch within an inductively coupled plasma-mass spectrometer having a triple quadrupole analyser;

FIG. 9 shows a plot illustrating the sensitivity limits of measurements within the inductively coupled plasma-mass spectrometer having a triple quadrupole analyser and equipped with an example of the disclosed torch;

FIG. 10 shows a plot of signal intensities over time when the voltage applied to the extraction lens is adjusted based on a measurable system parameter so as to maintain a constant reduced electric field (the plot illustrates good signal reproducibility in a four-hour experiment with a 1000 ppm EPA solution);

FIG. 11 shows a plot of signal intensities over time when the voltage applied to the extraction lens is kept constant (compared to FIG. 10, the plot illustrates lower signal reproducibility in a four-hour experiment with a 1000 ppm EPA solution);

FIG. 12 shows a plot of signal intensities over time to illustrate signal recovery obtained at the onset of a four-hour experiment with 1000 ppm EPA solution;

FIG. 13 shows a plot of signal intensities over time to illustrate signal recovery obtained at the end of the four-hour experiment with 1000 ppm EPA solution;

FIG. 14 shows photographs of a sampling cone and a skimmer taken after a four-hour experiment with 10% sea water (having a salinity of 0.35%, or 3500 ppm of the total salt concentration), using an example of the disclosed sampling interface and torch;

FIG. 14(a) shows the sampling cone before the experiment, FIG. 14(b) shows the skimmer before the experiment, FIG. 14(c) shows the sampling cone after the experiment and FIG. 14(d) shows the skimmer after the experiment; and

FIG. 15 shows a plot of signal intensities over longer time periods.

It will be understood that like features are labelled using like reference numerals. The figures are not to scale.

### DETAILED DESCRIPTION OF SPECIFIC EXAMPLES

This disclosure considers a sampling interface for use in a mass spectrometer and a method for using the same, as well as a torch for generating an inductively coupled plasma for use in an inductively coupled plasma-mass spectrometer. Each of the sampling interface and torch individually provide benefits compared to prior art designs, whilst the two aspects combine together to provide an improved overall system.

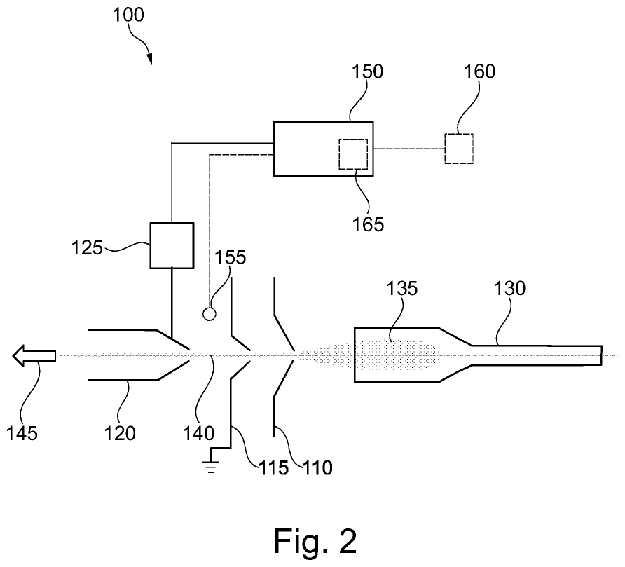

FIG. 2 shows a sampling interface 100 comprising an inlet (or a sampling cone) 110, a skimmer 115 and an extraction lens 120. In the particular example of FIG. 2, the inlet 110 comprises a sampling cone. The region between the inlet 110 and the skimmer 115 will further be referred to as an interface region. The sampling cone and skimmer 115 each comprise an aperture, through which particles or ions may pass. The inlet 110, skimmer 115 and extraction lens 120 are arranged such that particles and ions pass through these elements in this order. A variable or adjustable voltage source 125 is arranged to apply a bias voltage to the extraction lens 120. The skimmer 115 may be held at a predefined voltage, such as OV (and in the particular example of FIG. 2 is held at ground potential). A torch 130 (or conical torch) is arranged in proximity to the inlet 110 to the sampling interface 100, so that a plurality of particles generated at a plasma 135 at the torch 130 would pass through the inlet 110.

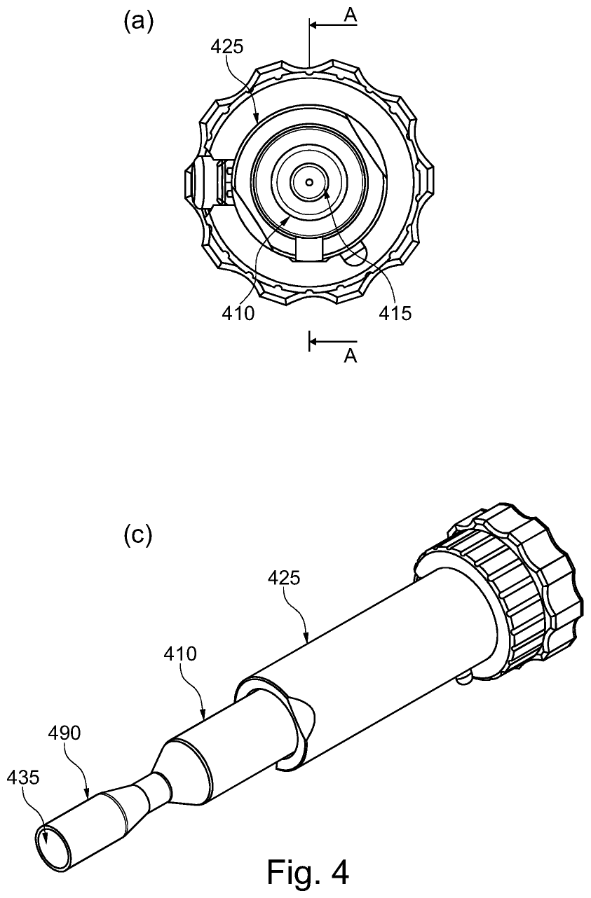

In use, an (e.g., inductively coupled) plasma may be generated at the torch 130. A sample may be supplied to the plasma, in order to generate sample ions. A plurality of particles generated at the plasma 135, including sample ions, may pass through the inlet 110 (for instance, through the aperture of the sampling cone). The internal diameter of the exit channel of the injector tube of a plasma torch for generating the plasma (for example, as described below with reference to FIG. 4) may have a ratio to the diameter of the aperture through the inlet 110 that is less than 1, so that the majority of the particles generated in the plasma pass unimpeded through the aperture of the inlet 110 (typically constituted by a sampling cone). The inlet also acts to provide a beam 140 of particles passing towards a mass analyser (not shown) of the mass spectrometer.

As the particles entrapped in plasma move downstream, they further pass through the aperture of the skimmer 115. The skimmer 115 enables a differential pressure drop in the interface region (typically in the range of 1.3 to 2 mbar) and the downstream region encompassing the extraction ion optics (typically having a pressure in the range of 2×10⁻³ mbar to 5×10⁻⁴ mbar). The electric field between the skimmer and the first extraction lens, to be referred to as extraction field, as well as the rapid drop of pressure downstream of the skimmer, result in extraction of the ionized particles out of plasma. In addition, the extraction field is also used to modulate the kinetic energy of the extracted ionized particles and to focus the particle beam.

In the present example, the skimmer 115 is grounded. Both the skimmer 115 and the sampling cone (here providing the inlet 110) can act as partial barriers between regions of differential pressure (for instance, as part of a differentially pumped transition from atmospheric pressure region at which the plasma 135 is generated at the torch 130, to a low pressure region of the mass analyser (mass analyser not shown in FIG. 2, but in the direction of arrow 145)).

The extraction lens 120 acts to extract ionized particles out of plasma, and to further focus those ions to provide a narrow ion beam passing towards the mass analyser (which is arranged further downstream of the sampling interface but is not shown in FIG. 2). Efficient extraction of ions out of plasma by the extraction lens 120 increases sampling efficiency and thereby increases analytical sensitivity. It should be noted that the plasma in the interface region between the inlet (e.g., the sampler) and skimmer is electrically neutral, so no extraction takes place here. Consequently, the extraction lens has no influence in the interface region.

In use, a bias voltage is applied to the extraction lens 120 via the adjustable voltage source 125. Application of bias voltage to the extraction lens 120 (with respect to the grounded skimmer 115) generates an electric field in at least a region between the extraction lens 120 and the skimmer 115. The adjustable voltage source 125 can be used to apply a bias voltage of a selected (in some cases, user defined) or determined magnitude.

The adjustable voltage source 125 is connected to a controller 150, which can adjust or initiate the applied bias voltage at the extraction lens 120. The controller 150 may be computer-implemented, or part of a computer system. The controller 150 is configured to receive a measured value of a system parameter (or equivalently, a measured system parameter). The controller 150 can then control (including apply or adjust) the magnitude of the bias voltage applied to the extraction lens 120 by the adjustable voltage source 125 based on the measured value of the system parameter.

The system parameter is a characteristic that can be measured (as a numerical value) in ‘real time’ and that is indicative of (e.g., proportional or inversely proportional to, or has a known relationship with) the magnitude of a reduced electric field in a region immediately downstream of the skimmer 115. The region may be at least part of a chamber between the skimmer 115 and the extraction lens 120, and is a region through which ions passing through the aperture of the skimmer 115 will inevitably pass.

The reduced electric field (which may also be known as the Townsend number) is a standard physical parameter related to the probability of ion-to-neutral particle collisions in the relevant region. The reduced electric field or Townsend number, T, may be defined as a ratio of the electric field, E, in at least the region between the extraction lens 120 and the skimmer 115 to the number density, n, in the region immediately downstream of the skimmer 115. As such:

T==E/n

In some examples, the measurable system parameter may be a direct measurement of the electric field or the number density. However, in other examples, the system parameter may be proportional to, or have a known relationship to, one of the electric field, E, or the number density, n. In a particular example, the measurable system parameter is a residual pressure (known as the extraction pressure) measured in the region between the skimmer 115 and the extraction lens 120. The pressure may be measured, for example by a pressure sensor 155 in the given region. The pressure sensor 155 may return a measurement of the pressure to the controller 150, to allow the controller to determine the bias voltage to be applied to the extraction lens 120. It will be understood that the measured pressure is a representation of the number density, n, and is proportional to the number density.

The controller 150, upon receiving the measured value of the system parameter, may determine the magnitude of the bias voltage to be applied to the extraction lens 120 based on the measured value. The determination may be based on a predefined relationship or algorithm. Said predefined relationship or algorithm may be stored in and retrieved from a storage device 160 in communication with the controller 150, and the determination may take place at a processor 165 comprised within the controller 150.

In a beneficial example, the applied bias voltage is determined so as to maintain the reduced electric field immediately downstream of the skimmer 115 at an approximately constant value. In other words, the predetermined relationship (between the applied bias and the system parameter) may be defined so as to maintain the reduced electric field at a predefined magnitude. The approximately constant value for the reduced electric field may mean maintaining the reduced electric field to be within ±10%, or even within ±5% or ±1%, of a predefined value.

For a particular example measurement using the described apparatus, an extraction (electric) field, E, (wherein E=V/d, where V is the difference between the skimmer bias and the voltage applied to the extraction lens 120 and d is the distance between the skimmer 115 and the lens 120) was adjusted to maintain the ratio of the extraction field, E, to the number density, n, substantially constant (this ratio being the reduced electric field, the so-called Townsend number). As noted above, the extraction field is proportional to the bias voltage applied at the extraction lens 120, and, in this example, the bias to be applied at the extraction lens 120 was calculated by the controller 150 based on a measurement of a pressure (which can be denoted the extraction pressure) between the skimmer 115 and the extraction lens 120. To determine the appropriate applied bias, the controller 150 uses a linear relationship between the measured pressure and the reduced electric field, such that the magnitude of the applied bias is calculated to maintain a constant reduced electric field. The initial setting of the reduced electric field (e.g., the Townsend number) is defined by the optimum extraction field at the initial extraction pressure as determined by the clean (uncontaminated) skimmer. Subsequently, the periodically or continuously measured pressure is used in a feedback loop to allow the controller 150 to repeatedly calculate the applied bias voltage at the extraction lens 120 that is required to maintain a constant reduced electric field.

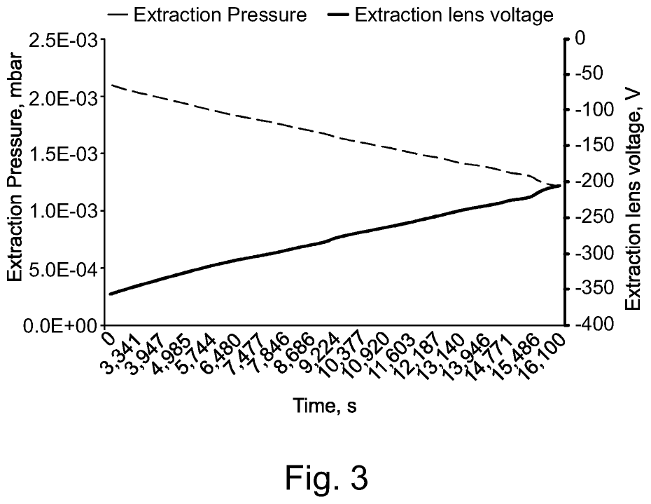

A plot of the applied voltage bias and the measured extraction pressure for an example measurement in which the reduced electric field immediately downstream of the skimmer 115 is kept constant is shown in FIG. 3. It can be seen that the applied magnitude of the voltage to the extraction lens 120 is proportional to the measured extraction pressure. In the particular example measurement from which the data of FIG. 3 was obtained, the pressure was monitored by a cold cathode gauge type pressure sensor 155 in the region between the skimmer 115 and the extraction lens 120. Further data obtained during this example measurement are discussed below.

The described apparatus can be used within a method for sampling of ions in a mass spectrometer for subsequent spectroscopic analysis. The method comprises first providing the sampling interface 100 as described above, including an inlet 110, a skimmer 115, an extraction lens 120, and an adjustable voltage source 125 for applying a bias voltage to the extraction lens 120 so as to generate an electric field in at least a region between the extraction lens 120 and the skimmer 115. In use, a quantity of particles passing through the sampling interface 100 may be generated at a torch 130, as described above.

According to the method, a bias voltage is applied to the extraction lens 120, wherein the magnitude of the bias voltage applied to the extraction lens 120 is based on a measured value of a system parameter, in order to control the reduced electric field in a region immediately downstream of the skimmer. The magnitude of the applied bias voltage may be controlled by a controller 150, as described above. The system parameter is, as described above, any measurable characteristic of the system (for instance, any characteristic that can be measured to yield a numerical value, including pressure or temperature) that is representative of the number density in a region immediately downstream of the skimmer and so has a known relationship to (for example, is proportional to) the magnitude of reduced electric field in a region immediately downstream of the skimmer 115.

According to the method, prior to the step of applying the bias voltage to the extraction lens 115, there may be a further step of measuring the value of the system parameter. This may involve measurement of the value at a sensor within the system, and receiving the measured value (for instance, at the controller 150). In one example, the system parameter is a measured pressure in a region between the skimmer 115 and the extraction lens 120. Once the system parameter has been measured, the method may include a further step of determining (for instance at the controller 150) the magnitude of the bias voltage to be applied to the extraction lens 120. The determination may be based on a predefined relationship between the applied bias voltage and the system parameter measured value. In some examples, the magnitude of the applied bias voltage may be determined (for instance, via the predefined relationship) so as to maintain the reduced electric field at an approximately constant value.

The torch 130 (or conical torch) in FIG. 2 that is used to generate a plasma 135, from which the plurality of particles is passed to the sampling interface 100, may be any known type of torch or conical torch with certain constraints to be discussed below. However, the inventors for the present disclosure have also identified particular improvements to the design of a known conical torch that, when combined with the above-described sampling interface, provide specific advantages. In particular, the improvements to the torch 130, as discussed below, can yield a higher temperature and a more focused beam of particles passing through the sampling interface 100. This in turn reduces or eliminates the build-up of substances at the inlet 110 and enables a constant interface pressure between the inlet 110 and the skimmer 115. Otherwise, a monotonous decrease in the interface pressure due to contamination of the inlet 110 may result in changes to the supersonic gas expansion into the interface region, accompanied by a monotonous increase in the Mach disk position. This process may detrimentally affect analytical sensitivity of the instrument and introduce an additional factor contributing to a pressure decrease in the extraction region. As a result, a more complicated approach may be required to deconvolute the pressure decrease due to the combined contamination of both the sampling cone and the skimmer. Accordingly, maintaining a constant interface pressure (being the pressure in the region between the inlet to the sampling interface and the skimmer) provides improved control of the reduced electric field downstream of the skimmer. Use of the disclosed torch allows the interface pressure to be maintained at an approximately constant value, as it provides for unimpeded passage of the charged particle stream generated at the plasma in the torch through the inlet to the sampling interface.

The improved torch 230 (or improved conical torch) is shown in FIG. 4. In particular, FIG. 4(a) shows a cross-section through the torch 230 in a radial plane, FIG. 4(b) shows a cross-section through the torch 230 in an axial plane, and FIG. 4(c) shows a perspective view of the torch 230.

The torch 230 is for generating an inductively coupled plasma, in particular to provide a quantity of particles (including sample ions) to a sampling interface of a mass spectrometer. The torch 230 comprises a torch tube 410 and an injector tube 415, wherein the injector tube 415 extends through the cavity (or bore) of the torch tube 410 (such that radially the torch tube 410 is arranged around and outside of the injector tube 415). In most circumstances, the torch tube 410 and injector tube 415 are arranged concentrically. Central axes of both tubes 410, 415 are aligned and extend in a longitudinal direction (having a dimension in the longitudinal direction greater than their individual radii). The axes through the tubes 410, 415 are substantially straight. The arrangement of the injector tube 415 through the torch tube 410 creates a channel 420 defined between the outer surface of the injector tube 415 and the inner surface (i.e., the surface of the bore) of the torch tube 410. This channel 420 can be used to pass a gas, such as a cooling and/or confining gas, for cooling the torch tube 410 and for containing a plasma generated at the torch 230 when the torch is in use.

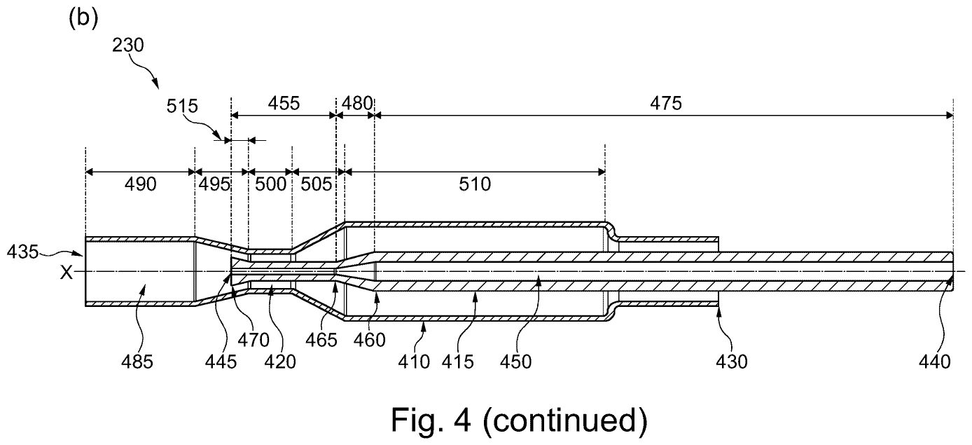

One end of each of the torch tube 410 and the injector tube 415 may be connected to a support apparatus (support apparatus 425 shown in FIGS. 4(a), 4(c) and 5 only). The support apparatus holds the injector tube 415 and torch tube 410 in position relative to each other. The end of the torch tube 410 is connected to the support apparatus and is denoted the support end 430, with the opposite end of the torch tube 410 denoted as an open end 435. The open end 435 of the torch tube 410 is open in the sense that it is not capped or closed. The end of the injector tube 415 closest to the support end 430 is denoted an injector inlet end 440, as it is the end through which a sample is injected into the bore 450 of the injector tube 415 when the torch is in use. The opposite end of the injector tube 415 is denoted the injector outlet end 445, being the end of the injector tube 415 from which the sample can be released when the torch is in use.

The bore 450 passing through the centre of the injector tube 415 (being a cavity for conveying a sample passing through the tube) is comprised of sections having a different diameter. In general, the bore 450 has a greater diameter at an end closest to the injector inlet end 440 than the diameter of the bore 450 closest to the injector outlet end 445. The bore 450 may taper to reduce the diameter at a certain section along its axial extension. A final section 455 of the bore 450, extending to terminate at the injector outlet end 445, will have a substantially constant diameter (in general, being the reduced, narrower diameter after the tapering section).

In a particular example, the diameter of the bore 450 through the injector tube 415 is greater at a first location 460 than at a second location 465. Furthermore, the diameter of the bore 450 is the same or greater at the second location 465 than at a third location 470. The first location 460 is closer to the injector inlet end 440 than the third location 470, and the second location 465 is between the first location 460 and third location 470 in the direction of extension of the bore 450 through the injector tube 415. In other words, the first location 460, second location 465 and third location 470 are arranged in that order in the direction of passage of a sample through the injector tube 415 from the injector inlet end 440 to the injector outlet end 445. In the example shown in FIG. 4, it can be seen that the bore 450 of the injector tube 415 extending from the injector inlet end 440 to the first location 460 has a first diameter, that is constant in this first section 475. The bore 450 of the injector tube 415 extending from the first location 460 to the second location 465 has a tapering or (gradually) reducing diameter, providing a second, conical (or frustoconical) section 480. Finally, the bore 450 of the injector tube 410 extending from the second location 465 to the third location 470 (which in the example of FIG. 4 is at the injector outlet end 470) has a second diameter, that is constant in this third section 455.

The first diameter is larger than the second diameter. In the specific example illustrated in FIG. 4, the diameter is around 3.9 mm in the first section 475 and the second diameter is around 1.0 mm in the third section 455, being constant along each length of respective sections 475, 455. More generally, the first diameter may be at least twice the second diameter, may be at least three times the second diameter, or may be at least four times the second diameter. The diameter being constant in the third section 455 means that the diameter at the second location 465 is not more than 110% the diameter of at third location 470, and ideally no more than 105%, or even 101%. In a particular example, the diameter at the second location 465 is equal to the diameter at the third location 470. The distance between the second location 465 and third location 470 is typically at least five times the diameter of the bore at the second location 465, or may be at least ten times the diameter at the second location 465.

Provision of an injector tube 415 having a reducing diameter, wherein the reducing or tapering portion 480 is spaced apart from the injector outlet end 445, provides a number of advantages. In particular, the sample (for example in the form of a nebulized gas) entering the injector tube 415 through the region 475 of wider bore diameter becomes constricted as the sample passes through the region 480 of narrowing bore diameter, which in turn causes acceleration of the gas flow and focusing to a narrower stream of particles at the exit from the injector outlet end 445. Due to the extended torch straight section near the injector outlet end 445 and the reducing injector tube bore diameter in the direction of flow, as well as lower cool gas flow of the torch, there is a higher efficiency coupling of the RF power to plasma and improved energy transfer to the plasma central channel. This results in a higher measured plasma temperature when using the torch 230 with the injector tube 415 as compared to many known torch configurations.

In the example of FIG. 4, the injector tube 415 is positioned to extend only partially through the length of the bore of the torch tube 410. In particular, the injector outlet end 445 is displaced from the open end 435 of the torch tube 410, inside the torch tube. This creates a portion of the torch tube 410 at the open end 435 in which the injector tube 415 does not extend through the bore, forming an open ended cylindrical or partial cone shaped cavity 485 in the open end 435 of the torch tube 410. Said cavity 485 is here denoted a containing section 490 of the torch tube 410. When the torch 230 is in use, at least a portion of the plasma may be generated within the containing section 490.

The torch tube 410 (or at least the bore of the torch tube 410) may comprise a conical (frustoconical) or tapering section. In particular, the bore of the torch tube 410 widens towards the open end 435 compared to a preceding section closer to the support end 430. In the example of FIG. 4, the bore of the torch tube 410 has various sections arranged between the support end 430 and the open end 435 as follows: a) a first section 510 of constant first diameter along a region close to the support end 430, b) a conical (frustoconical) section 505 at which the bore diameter is reduced to a second diameter, c) a third section 500 with a constant diameter (being the second diameter), d) a conical (frustoconical) fourth section 495 that is partially aligned with the injector outlet end 445, and which widens to a third diameter, and e) a fifth section 490 comprising the containing section and having a constant diameter (being the third diameter). It will be understood that the second diameter is less than the first and third diameter, to provide a narrowed third section 500 of the bore of the torch tube 410. The first and third diameter may be the same, or different. In the particular example of FIG. 4, the first diameter is larger than the third diameter, although in some examples the first and third diameter may be the same, or different. Advantageously, the narrowed third section 500 creates a reduction of the dimension of the channel 420 between the inner wall of the torch tube 410 and the outer wall of the injector tube 415, which consequentially acts to accelerate the axial velocity of a gas flowing through the channel 420. When the torch 230 is in use, greater acceleration of the gas (which may be denoted a confining gas) causes better confinement of the plasma generated, as well as a greater cooling power to avoid damage to or melting of the torch tube 410.

The outer diameter of the injector tube 415 may be constant along its whole length or, as shown in FIG. 4, the outer diameter of the injector tube 415 may taper and increase at a portion preceding and terminating at the injector outlet end 445. Said widening, tapering (or conical) portion 515 of the outer diameter of the injector tube 415 may at least partially align with the widening conical portion at the fourth section 495 of the torch tube 410, as described above. In particular, the widening conical (or frustoconical) region 515 at the outer surface of the injector tube 415 and the bore of the torch tube 410 may be aligned such that, in this widening region 515, the spacing in the radial direction is equal to the spacing in the radial direction through the narrowed, third section 500 of the torch tube bore. In other words, the channel defined between the outer surface of the injector tube 415 and the inner surface of the torch tube 410 will have a constant radial width throughout the region adjacent the narrowed third section 500 of the torch tube 410 and the widening conical section 515 of the injector tube 415. The conical section 515 at the outer surface of the injector tube 415, as described, further acts to maintain the higher velocity of the already accelerated gas passing through the narrowed channel 420 defined between the outer surface of the injector tube 415 and the inner surface of the torch tube 410, as well as to direct the flow of the confining gas through the containing section of the torch tube 410. The spacing between the widening, conical portion 515 of the outer surface of the injector tube 415 and the inner surface of the torch tube 410 can be selected so that the axial velocity of a gas passing from the support end 430 of the torch tube 410 towards the open end 435 of the torch tube 410 experiences sufficient acceleration to provide good containment of the plasma.

The torch 230 further comprises a load coil 550, as shown in FIG. 5. The load coil 550 acts to pass a high power, high frequency electric current and, together with the other components of the torch, creates an intensive magnetic field to generate a more stable and high temperature plasma. The load coil 550 is coiled around the outer surface of the torch tube 410 so as to be aligned with a portion of the containing section 490. The load coil 550 extends in a helical fashion around the axis of the torch tube 410 from a first point 555 (closer to the support end 430) to a second point 560 (closer to the open end 435). In the example of FIG. 5, the first point 555 is spaced apart in the axial direction from the injector outlet end 445. In particular the spacing 570 is 1 mm or more. The second point 560 at the load coil 550 is also spaced apart in the axial direction from the open end 435 of the torch tube 410 (by a spacing 575 of 3 mm or more in the example of FIG. 5). Beneficially, the identified spacing 570 between the injector outlet end 445 and the first point 555 at the load coil 550 prevents or reduces plasma quenching and melting of the torch due to the high plasma temperatures. Moreover, the containing section 490 of the torch tube 410 extending past the load coil 550 (by the identified spacing 575 between the second point 560 at the load coil 550 and the open end 435 of the torch tube 410) supports a further increase in the plasma temperature as well as better collimation of the particle stream. In will be understood that such an arrangement of a load coil 550 (having the spacings as discussed) could advantageously be applied to an arrangement for the torch even without the specific configuration for the injector tube 415 as described above and shown in FIGS. 4 and 5. As such, the arrangement of the load coil 550 may provide technical benefits that are separable from the other features of the described torch 230, but which are further complimentary with the benefits provided by the other features so as to improve apparatus performance overall.

Advantageously, the conical plasma torch 230 as shown in FIGS. 4 and 5 can be used to generate a higher-temperature and more confined plasma than prior art designs. In particular, the described torch 230 provides an ion temperature over 10,000 K and a fine stream of charged particles confined to a beam having a diameter of less than 1 mm. These aspects, in turn reduce build-up of high-matrix contaminants at elements of the sampling interface, which can otherwise lead to an unstable reduced electric field downstream of the skimmer and a resulting degradation in measurement performance.

Furthermore, the described torch 230 can be used in conjunction with, or comprise part of, the described sampling interface 100 to provide an improved overall system for inductively coupled plasma-mass spectrometry. More specifically, when the torch 230 is in use to form a plasma 600, a fluid is passed through the bore of the injector tube 415 from the injector inlet end 440 towards the injector outlet end 445. The fluid may comprise a liquid or gas. After passing out of the injector outlet end 445 and into the region of the containing section 490 of the torch tube 415, a plasma can be generated or ignited. A liquid or gas sample for analysis can be introduced into the fluid through the injector tube 415, to be injected into the generated plasma. The presence of the reducing bore diameter of the injector tube 415 increases the acceleration of the fluid passing through the tube, thereby increasing the temperature of the generated plasma. The reducing bore diameter, coupled with the extended section of the bore having the reduced diameter immediately prior to the injector outlet end, also helps provide a more collimated beam. Overall, plasma temperature is defined by the coupling of the RF power and the cool gas flow. The plasma temperature of the central channel (closest to the centre of the flow) is lower than the plasma temperature at the periphery (radially extending away from the centre of the flow). In an ideal system, an efficient energy transfer from plasma at the periphery (closer to the torch walls) to the central channel is achieved.

At the same time, a gas (denoted here a confining gas) is passed through the channel 420 between the outer surface of the injector tube 415 and the inner surface of the torch tube 410. This gas moves though the channel 420 to pass a ring of confining gas around the generated plasma in the containing section 490 of the torch tube 410. The confining gas acts to better confine the plasma (to give a narrower beam of particles output from the plasma) and also to cool the torch tube 410 and injector tube 415. The tapering section 515 to widen the diameter of the outer surface of the injector tube 415, in conjunction with the tapering section 495 to widen the diameter of the bore of the torch tube 410 as it approaches the containing section 490, acts to increase the acceleration of the confining gas through the defined channel 420.

Particles (including ions or neutral particles) are entrained in plasma and pass towards the sampling interface 100 and then through the sampling interface 100 towards a mass analyser. The described features of the torch 230 provide a higher temperature plasma than prior art devices, as well as a narrower beam of higher velocity particles passing through the inlet 110 and the skimmer 115 of the sampling interface. This in turn results in less build up at the apertures of the inlet 110 and skimmer 115, and as a consequence, over the course of an extended experiment, the deviation in the reduced electric field (or Townsend number) in the region immediately downstream of the skimmer 115 is reduced. Furthermore, any deviation in the reduced electric field can be successfully mitigated by the bias voltage applied to the extraction lens 120 of the sampling interface 100 as discussed above (a technique which itself further acts to reduce build-up at the skimmer).

A relevant characteristic of the described torch is the ratio of the internal diameter of the injector tube at the injector outlet end to the diameter of the aperture through the inlet 110 (or sampling cone) at the sampling interface 100. This ratio should remain below 1, so that particles moving through the central channel of the inductively coupled plasma propagate through the sampling cone unimpeded. This feature prevents contamination (i.e., build up) at the aperture of the inlet 110 and provides constant pressure in the interface region (between the inlet and the skimmer) throughout long-term experiments with high-matrix samples. Prevention of inlet contamination results in reproducible supersonic gas expansion into the interface region and makes ion extraction from plasma a function of only one independent variable, such as the extraction pressure past the skimmer aperture 115. As previously noted, this is beneficial because degradation to the instrument performance due to contamination of the skimmer 115 could then be addressed by maintaining the reduced electric field at a constant value.

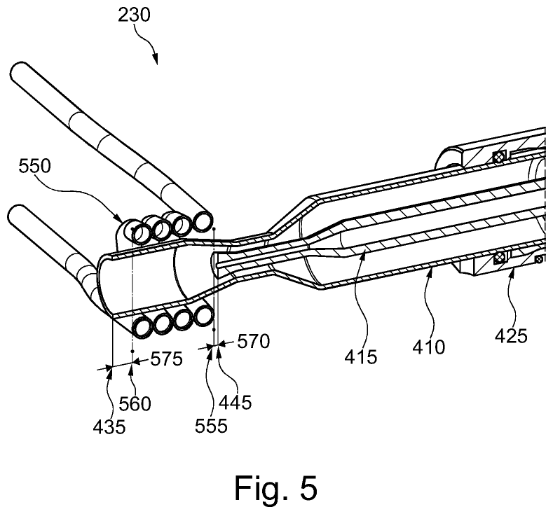

FIG. 6 shows a photographic representation of the torch 230 in use, wherein the inductively coupled plasma 600 is generated in the containing section 490 of the conical torch. The load coil 550 and the torch tube 410 are visible in the photographic representation. A plurality of particles emanating from the plasma 600 can be seen to pass towards and through an aperture at an inlet 110 of the sampling interface 100 (wherein the inlet is a sampling cone in FIG. 6). In the particular measurement imaged in FIG. 6, the bore diameter at the injector outlet end (injector tube not visible) is 1 mm. Finely dispersed aerosol particles are nebulized upon exiting the injector tube and passed into the high-temperature plasma at a nebulizer flow rate of 0.9 millilitre per minute. The load coil 550 is positioned just downstream of the injector outlet end, whilst also being upstream of the open end of the torch tube 410, thereby acting to reduce plasma quenching and melting of the torch. A portion of the containing section 490 of the torch tube 410 extends past the load coil 550, which enables a further increase in the plasma temperature and better collimation of the particle stream therefrom.

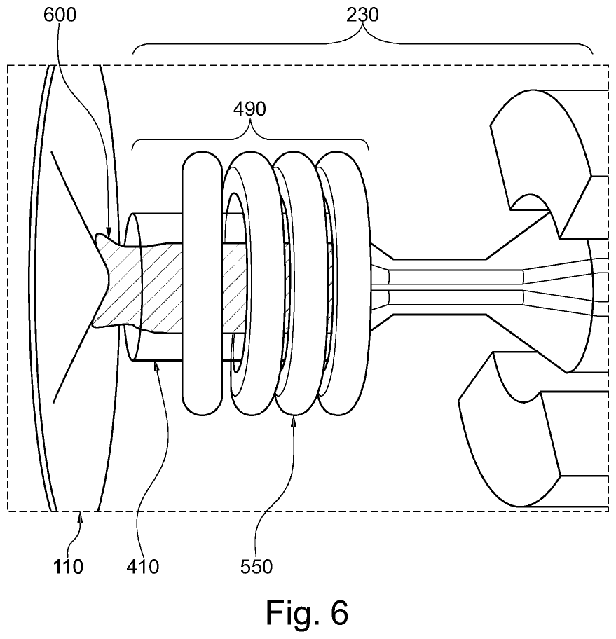

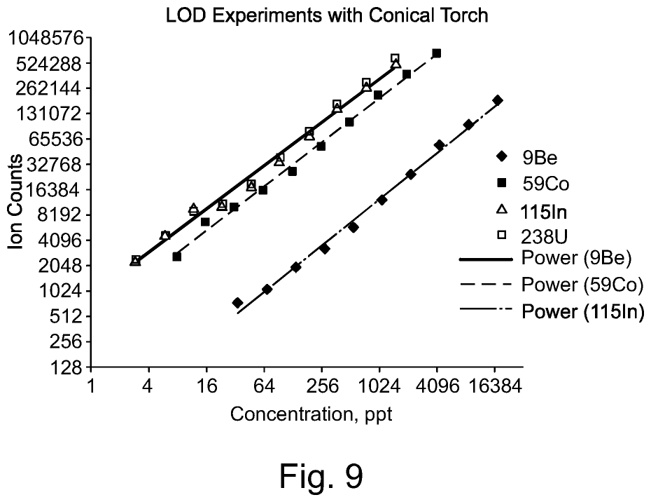

FIGS. 7 to 15 show various measurements characterising the described sampling interface 100 and torch 230. The measurements each consider a plasma generated with a 1 parts-per-billion (ppb) calibration solution using apparatus according to the present disclosure. More specifically, FIGS. 7, 8 and 9 illustrate the particular benefits provided by the disclosed torch 230, and FIGS. 10 to 15 illustrate the reduction in measurement degradation provided with use of the disclosed sampling interface 100. Together the torch 230 and sampling interface act to reduce build-up and contamination at the inlet (sampling cone) and skimmer, which reduces the consequent negative effects for the measurement performance.

FIG. 7 shows a measurement of signal intensity over time from which the plasma temperature of the conical torch can be determined as a ratio of the doubly-charged Ba and U signals to their singly-charged counterparts. FIG. 7 demonstrates that the plasma temperature achieved is over 10,000 K as compared to 7,500 K in the conventional Fassel torch.

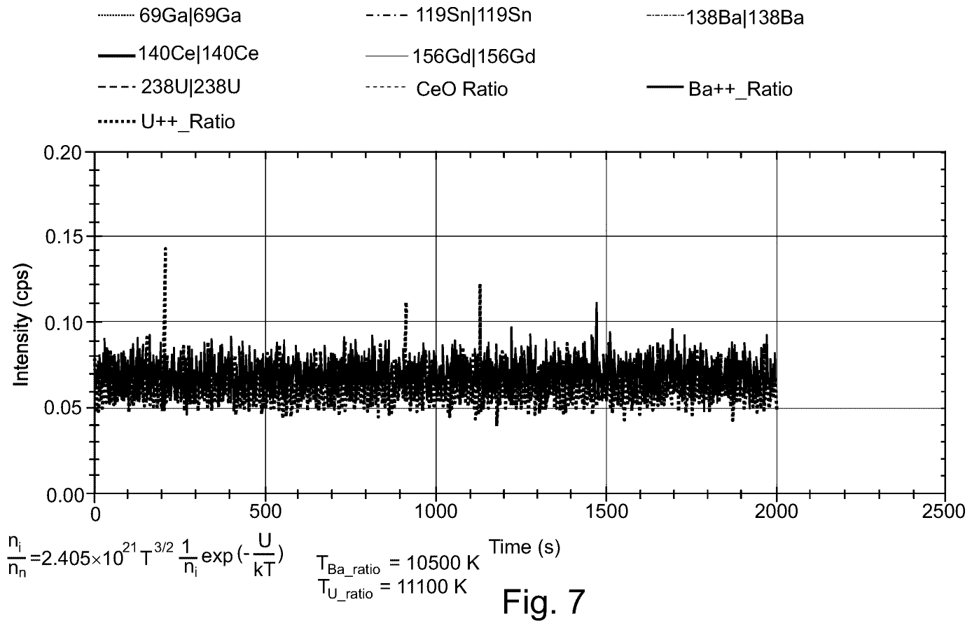

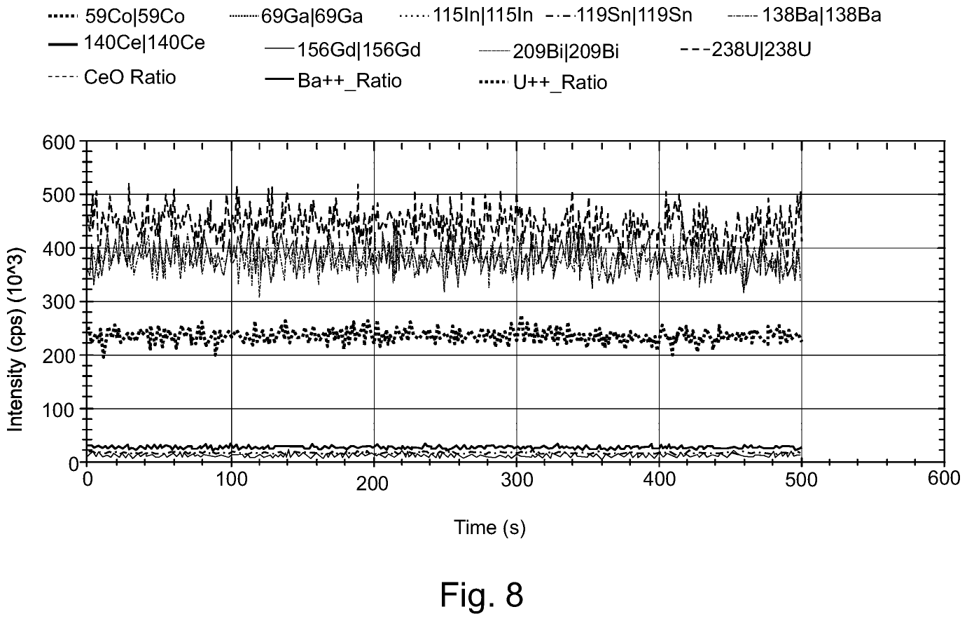

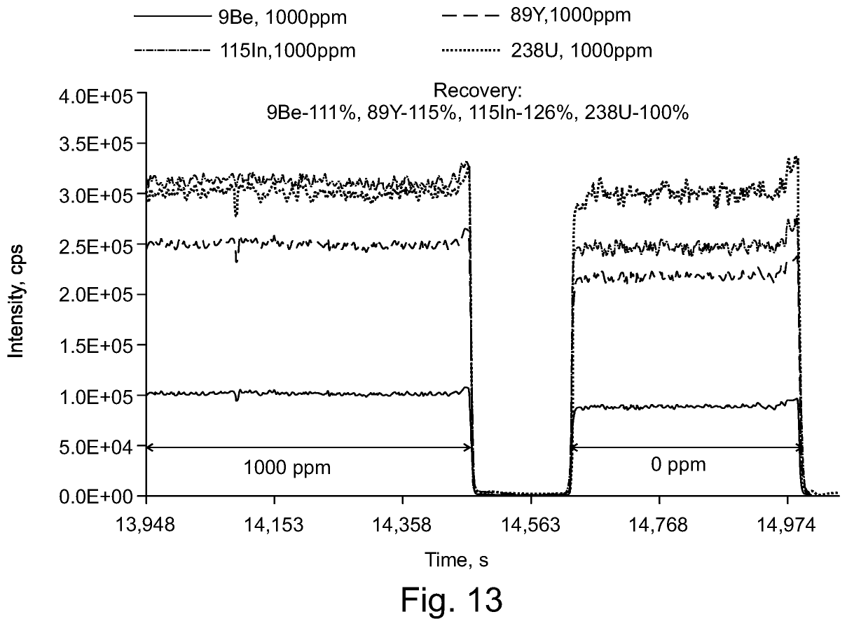

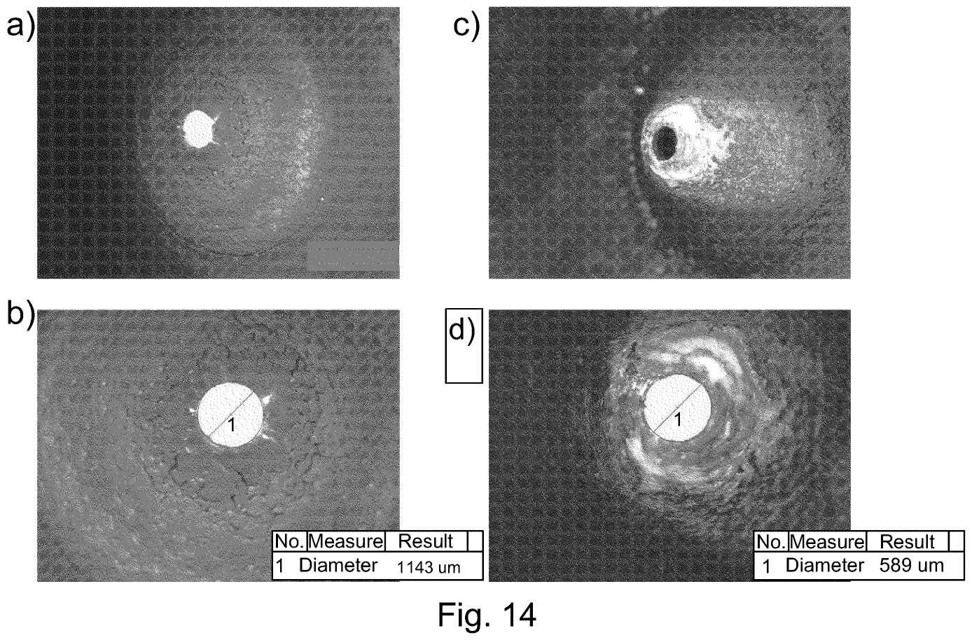

FIG. 8 shows the signal intensities over time for the analysis of the 1 ppb calibration solution using the disclosed conical torch within an inductively coupled plasma-mass spectrometer comprising a triple quadrupole analyser and equipped with the disclosed conical torch. Here, the sampling cone has an aperture of 1.1. mm and a skimmer aperture diameter of 0.5 mm. FIG. 9 shows the limits of detection at the same inductively coupled plasma-mass spectrometer comprising a triple quadrupole analyser. In reference to analysis of solutions with a high matrix content (US Environmental Protection Agency (EPA) solution, 1000 ppm overall matrix concentration), it was found that the use of the disclosed torch 230 significantly reduced contamination of a 1.1 mm diameter aperture sampling cone over a four-hour experiment. This was indicated both by a stable pressure measured in the region between the sampling cone and the skimmer and by the visual analysis of the sampling cone under a microscope (for instance, as illustrated by the photographs at FIG. 14 and discussed further below).

To further improve signal recovery from high-matrix solution samples, it was found that the open end 435 of the torch tube 410 should be positioned (or recessed along the z-axis, that is the interface axis) from the inlet 110 (being the sampling cone entrance). The optimum spacing between the torch tube 410 and inlet 110 was found to be 8 mm, although the spacing may be between 5 and 10 mm, for instance. It was noted that no further increase in the nebulizer (confining gas) flow rate was required to mitigate this distance between the conical torch and sampling cone, which indicates that the radial confinement of the particle stream has a diameter of less than 1 mm. As discussed above, said radial confinement, which is greater than that many prior art conical torches, is a consequence of the reducing diameter of the bore of the injector tube 415, the protrusion of the torch tube 410 beyond the injector outlet end 445 (e.g., at the containing section 490) as well as the relative arrangement of the load coil 550 around the containing section 490. The ability to increase the recess (spacing) of the torch 230 relative to the inlet 110 to the sampling interface 100 enables longer residence time of the analytes in the higher temperature plasma. This in turn facilitates better ionization efficiency and improved signal recovery.

FIGS. 10, 11, 12 and 13 show the performance of an inductively coupled plasma-triple quadrupole mass spectrometry measurement, the measurement making use of the described sampling interface 100 comprising the disclosed torch 230. The experiment took place with EPA solution (1000 ppm matrix, including Na, Ca, K, Mg and Fe, all at 200 ppm).

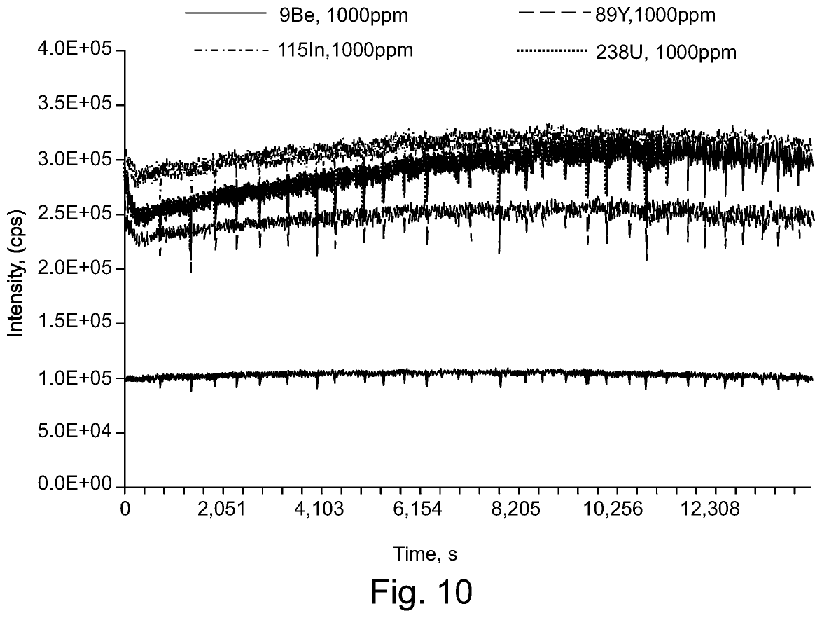

FIG. 10 shows signal reproducibility for signal intensities of ⁹Be, ⁸⁹Y, ¹¹⁵In and ²³⁸U measured throughout a four-hour experiment. Here, the extraction field (generated as a consequence of bias voltage applied to the extraction lens 120) was adjusted during the measurement based on monitoring of the pressure between the skimmer 115 and the extraction lens 120, in order to maintain a constant reduced electric field immediately downstream of the skimmer 115. No significant signal intensity decrease was observed despite some build-up at the skimmer being apparent after the experiment. For comparison, FIG. 11 shows the signal reproducibility for signal intensities of ⁹Be, ⁸⁹Y, ¹¹⁵In and ²³⁸U measured throughout a four-hour experiment, but in a case where the extraction field was kept constant (i.e., there was no pressure-dependent adjustment of the extraction field). A gradual decrease of the ion signals was observed under these operation parameters.

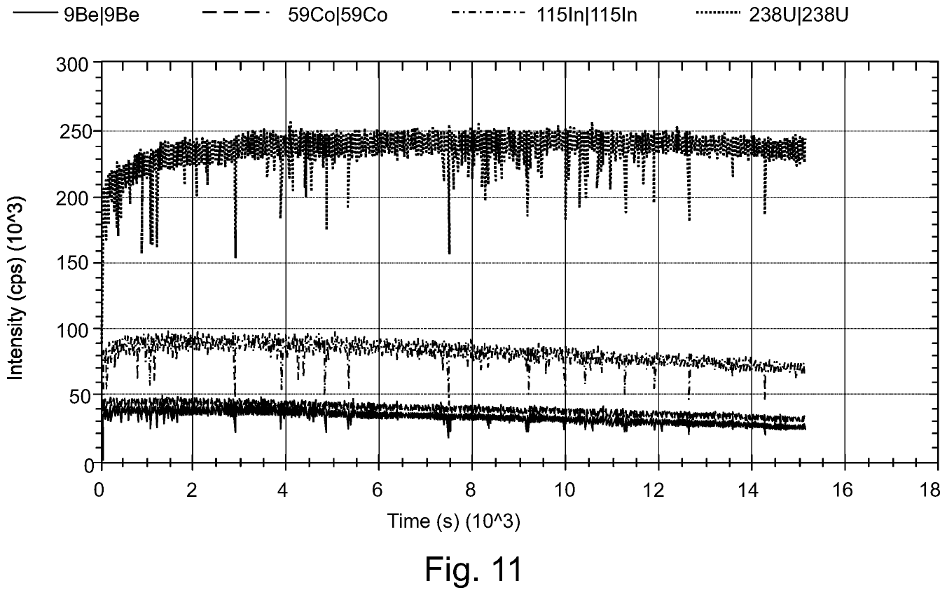

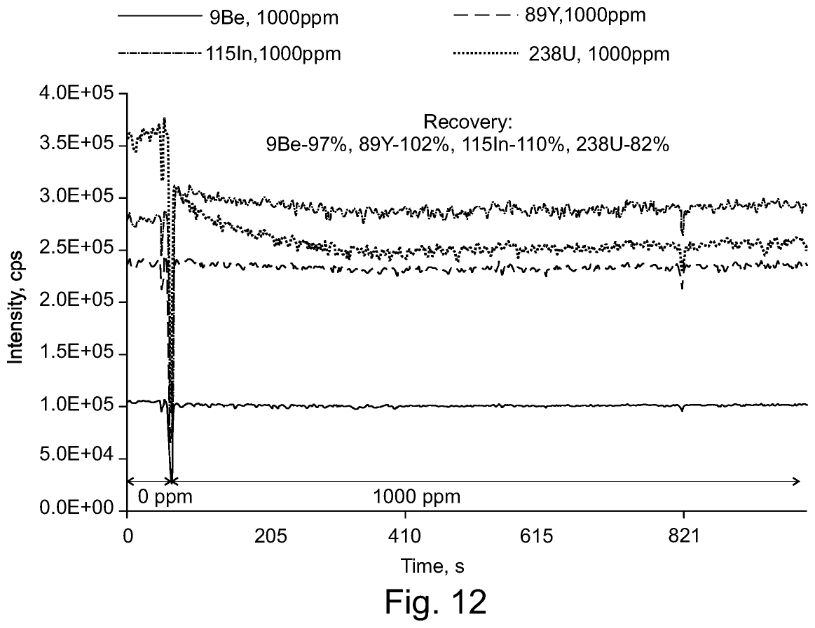

FIGS. 12 and 13 show the recovery efficiency of the monitored elements prior to and after the four-hour experiment with the highly concentrated sample used to provide the results shown in FIG. 10 (in other words, during which the bias applied to the extraction lens was adjusted to provide a constant reduced electric field). FIG. 12 shows the signal recovery obtained at the onset of the four-hour experiment, whereas FIG. 13 shows the signal recovery obtained at the end of the four-hour experiment. As illustrated by the data, the signal recovery was found to be in the range of 80% (238U at the beginning of the four-hour experiment) to 120% (at the end of the four-hour experiment).

FIG. 14 shows images of the sampling cone and skimmer taken before and after the four-hour experiment with the highly concentrated sample used to provide the results shown in FIG. 10. Images of the sampling cone before (FIG. 14(a)) and after (FIG. 14(b)) the experiment, as well as the skimmer before (FIG. 14(c)) and after (FIG. 14(d)) the experiment show that the initial internal diameters of 1.1 mm and 0.6 mm at the sampling cone and skimmer, respectively, remain practically unchanged. In the course of a four-hour experiment, the total pressure-dependent adjustment of the applied bias voltage on the extraction lens was around 35 V (from −330 V to −295 V). Both the novel configuration of the torch 230 and the technique of applying a bias voltage at the extraction lens of the sampling interface act to reduce the build-up and contamination at the apertures of the sampling cone and skimmer, maintaining the overall measurement quality.

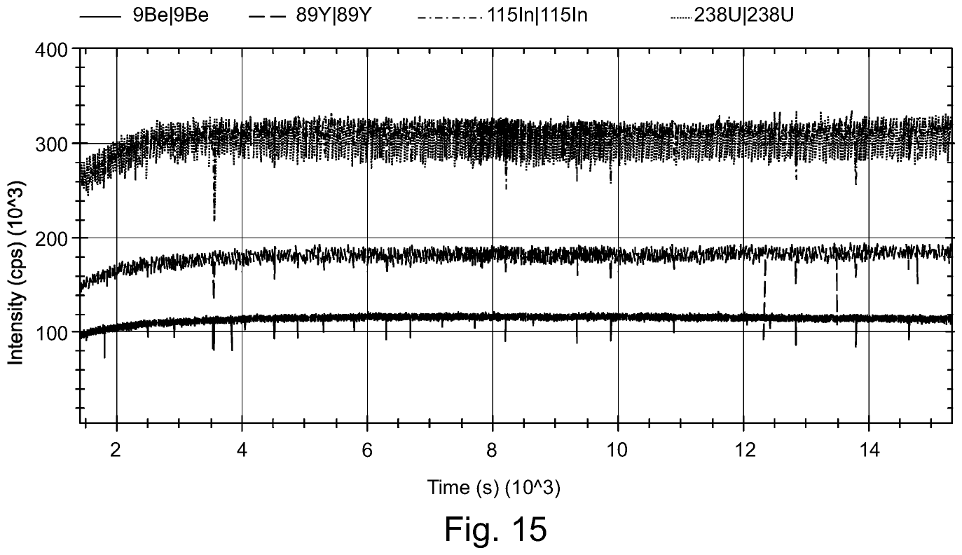

FIG. 15 shows a plot of signal intensities of a longer time period of measurement (in particular, measurement of 10 ppb ⁹Be, 1 ppb ⁸⁹Y, 1 ppb ¹¹⁵In and 1 ppb ²³⁸U spiked in 10% sea water). The plot shows data record over the full four-hour period, during which the extraction field was data-dependently adjusted (in other words, the bias applied to the extraction lens was adjusted) based on readings of the pressure measured in a region between the skimmer and the extraction lens. As noted for FIG. 14, the overall adjustment for the applied bias was around 35 V (from −330 V down to −295 V) at the extraction lens. In similar to the experiments with an EPA matrix, no signal decrease was observed over the entire four-hour experiment.

Although embodiments according to the disclosure have been described with reference to particular types of devices and applications (particularly inductively coupled plasma-mass spectrometry) and the embodiments have particular advantages in such case, as discussed herein, approaches according to the disclosure may be applied to other types of device and/or application. Certain features may be omitted or substituted, for example as indicated herein. Each feature disclosed in this specification, unless stated otherwise, may be replaced by alternative features serving the same, equivalent or similar purpose. Thus, unless stated otherwise, each feature disclosed is one example only of a generic series of equivalent or similar features.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein. For instance, the sequencing of the switchable value in either the ‘first’ or ‘second’ position of the multi-way valve is arbitrary.

As used herein, including in the claims, unless the context indicates otherwise, singular forms of terms are to be construed as including the plural form and vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B” is true, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element or position may instead be termed a “second” element or position and an element termed a “second” element or position may instead be considered a “first” element or position.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative and not limiting, unless implicitly or explicitly understood or stated otherwise.

All literature and similar materials cited in this disclosure, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

According to the specific examples described above, this disclosure considers a sampling interface for use in mass spectroscopy apparatus, and a method for using the same, as well as a torch for generating an inductively coupled plasma. The sampling interface may comprise the described torch. In particular, the inventors for the present disclosure have recognised that degradation of instrument performance results from contamination of instrument elements (such as the skimmer or sampling cone) downstream of the torch at which the plasma is generated. This in turn causes a change of the ion number compared to the neutral particle number in a region downstream of the skimmer of the apparatus. The inventors have further recognised that reduced electric field is an indicator of the effects of contamination, wherein providing an instrument in which the reduced electric field (i.e., represented by the Townsend number) downstream of skimmer can be kept constant would improve the issues of performance degradation of the instrument.

The inventors have identified that a constant reduced electric field can be provided by two mechanisms, which may be complementary. These mechanisms are: a) by providing sufficient control of the electric field downstream of the skimmer to account for changes in the number density, and therefore to fulfil the objective of a constant reduced electric field by mitigating a change in number density with a change in the electric field; and b) reducing build up or contamination at the apertures of an inlet and/or skimmer of the sampling interface. Reducing build-up or contamination at the orifice at the skimmer can itself be provided by i) use of a higher temperature plasma to generate the sample ions; and ii) improving the confinement of the high temperature plasma at the torch, to give a more focused stream of particles to pass through the orifice at the inlet and skimmer of the sampling interface.

Better focusing of the stream of charged particles allows the charged particles to pass unimpeded through the skimmer, and this in turn avoids a substantial increase in pressure in the region between the inlet to a sampling interface and the skimmer. The consequent approximately constant pressure in an interface region between the inlet and the skimmer allows for easier control of the reduced electric field in the region downstream of the skimmer. As such, use of the described torch (which achieves the effects (i) and (ii) above) together with the described sampling interface may result in a system that has overall superior performance. In other words, the inventors have recognised the physical phenomena causing known problems relating to instrument performance degradation, and furthermore they have identified certain instrument operation parameters and characteristics that can avoid or reduce the presence of said physical phenomena, to improve the overall performance issues.

The sampling interface used to implement the mechanisms described above is outlined in this disclosure. In particular, the sampling interface itself (having an adjustable voltage source for applying a bias voltage to the extraction lens) can be used to vary the electric field sufficiently to achieve mechanism (a), yet without disrupting the electric field in portions of the instrument upstream which could also affect the plasma generated at the torch. The torch described in this disclosure can be used to achieve mechanism (b) (and the related benefits of (i) and (ii)). The described sampling interface also acts to assist mechanism (b), as it has also been also observed that application of a bias at the extraction lens (as opposed to other elements) can help reduce build-up at the skimmer. Although there may be individual and separable benefits of both the sampling apparatus and the torch described, particular improvements to avoid performance degradation of the overall instrument can be obtained by the combination of the described sampling interface and torch.

In a first described example there is a sampling interface for use in mass spectroscopy apparatus, the sampling interface being arranged so as to enable the sampling of ions in a mass spectrometer for subsequent spectroscopic analysis, the sampling interface comprising:
an inlet for receiving a quantity of particles from an ion source, the quantity of particles including ions for spectroscopic analysis;
a skimmer arranged downstream of the inlet, the skimmer comprising an aperture through which particles from the inlet pass;
an extraction lens arranged downstream of the skimmer, the extraction lens being configured for extracting ions from the particles passed through the aperture at the skimmer;
an adjustable voltage source for applying a bias voltage to the extraction lens so as to generate an electric field in at least a region between the extraction lens and the skimmer; and
a controller configured to control the adjustable voltage source to apply a bias voltage to the extraction lens (that is, adjust the bias voltage at the extraction lens), in order to control the reduced electric field in the region immediately downstream of the skimmer.

The sampling interface is a portion of a mass spectrometer arranged to enable the sampling of ions from a generated plasma and passage of those sampled ions towards a mass analyser for subsequent spectroscopic analysis and detection. The sampling interface can be considered a delivery system for a portion of ions generated at a plasma of a mass spectrometer.

A sample may be introduced into a plasma (for instance, at a torch, as described elsewhere in this disclosure). A quantity of particles will pass out of the plasma, and the quantity of particles can include ionised and non-ionised particles. The quantity of particles will include at least some ions of the sample (“sample ions”) intended to be analysed by spectroscopic analysis. As such, the quantity of particles may be received from an ion source entrapped in plasma, and the extraction lens may be configured for extracting ions from the plasma.

The sampling interface comprises an inlet. The inlet typically includes an aperture or orifice through which a portion of the particles from the plasma can pass. The inlet may be a sampling cone (also known as a sampler). The inlet may allow only a portion of the particles from the plasma to pass through its aperture and onwards towards the analyser of the mass spectrometer. The analyser may be of any suitable type for spectroscopic analysis, for example a quadrupole mass analyser.

The skimmer is a component of the sampling interface, comprising an aperture through which particles (including sample ions) can pass so as to allow movement towards the analyser of the mass spectrometer. Typically, the skimmer is a cone like component having a circular orifice (the aperture) at its apex. The skimmer may be used to ‘skim’ or remove the outer portions of the particle beam (and prevent passage of these outer portions), so as to narrow and collimate the particle beam. The skimmer can also act as a partial barrier between regions of differential pressure (for instance as part of a differentially pumped transition from an atmospheric pressure region at which the plasma is generated, to a low pressure region of the mass analyser). The skimmer may be grounded, that is, to be held at zero volts.

The direction of movement of the particles (i.e., through the aperture of the inlet and skimmer) denotes components being “downstream” or “upstream”. In general, the particles move in a direction extending through the inlet and then moving downstream towards the mass analyser.

The extraction lens acts to extract charged particles (or ions) out of plasma, and to focus those ions to provide a narrow ion beam passing towards the mass analyser. Efficient extraction of ions by the extraction lens modulates the kinetic energy of the extracted ionized particles and increases analytical sensitivity.

The adjustable voltage source is used to apply a voltage (or potential difference) to the extraction lens, in order to generate an electric field between the extraction lens and the skimmer (which itself may be grounded). The magnitude of the voltage applied by the adjustable voltage source can be straightforwardly modified or adjusted by a user (for instance via a controller).

The region immediately downstream of the skimmer is a region through which all particles passed through the skimmer aperture will travel. The region immediately downstream of the skimmer may be in a chamber configured between the skimmer and the extraction lens.

The controller may be an element (including a computer implemented element) that can be used to send instructions to the adjustable voltage source to modify the voltage output from the voltage source. The controller may further receive commands from a user to make such adjustments. Furthermore, the controller may receive measured values from the system (for instance, measured at sensors within the system), and use those measured values to make processing decisions. For instance, the measured values may be used in a predefined algorithm by the controller to determine a magnitude of the bias voltage to be applied to the extraction lens and calculate an adjustment that should be made to the magnitude of the voltage applied by the voltage source. The controller may comprise a computer processor together with computer readable data storage, such that a program or algorithm retrieved from the data storage by the processor can be executed so as to perform an operation at or control another element of the system.

The reduced electric field is a physical parameter having a meaning defined in the art. The reduced electric field, T, is defined as a ratio of the electric field, E (here, in at least the region between the extraction lens and the skimmer) to the number density, n (here, in the region immediately downstream of the skimmer). The number density can be considered to represent the number of neutral particles per unit volume (in other words, the neutral particles within the background gas or collision gas). The ratio known as the reduced electric field has the unit of Townsend (Td) (see for example https://en.wikipedia.org/wiki/Townsend_(unit), accessed 15 Jun. 2023, which may be equivalent to 10⁻²¹ Vm²), and the ratio is sometimes denoted the Townsend number. As such:

$$T = \frac{E}{n}$$

The reduced electric field, T, is related to the probability of ion-neutral particle collisions in the relevant region (here being the region between the extraction lens and the skimmer in the present case).

In view of the relationship above, the reduced electric field (or Townsend number), T, may be maintained at a constant value by increasing the electric field, E, in response to an increase in the number density, n, in the region immediately downstream of the skimmer. The electric field E in a region immediately downstream of the skimmer is directly related to the bias voltage applied to the extraction lens (in particular, E=V/d, where V is the difference between the skimmer bias and the voltage applied to the extraction lens and d is the distance between the skimmer and the extraction lens). As noted below, the number density, n, in the region immediately downstream of the skimmer can be monitored by measurement of a system parameter, such as pressure, in that region. For instance, the ideal gas law (pV=nRT) can give an approximate but accurate indication of the number density, n, for the volume, V, of the region between the skimmer and the extraction lens by measurement of pressure, P, in this region. The temperature, T, in this region can be assumed to be constant, although could also be measured by a sensor in the region between the skimmer and the extraction lens. It will be understood that R is the ideal gas constant. As such, measurement of a pressure, P, in a region between the skimmer and the extraction lens can be translated to a voltage to be applied to the extraction lens in order to maintain the reduced electric field (or Townsend number), T, at an approximately constant value. Keeping the reduced electric field at an approximately constant value can take account of (or mitigate against) degradation to the instrument performance due to any (inevitable) contamination of the skimmer during a long experiment cycle.

The controller may be configured to determine a magnitude of the bias voltage to be applied by the adjustable voltage source to the extraction lens based on a measured value of a system parameter representative of the number density in a region immediately downstream of the skimmer. The determination takes place prior to controlling the magnitude of the bias voltage applied to the extraction lens by the adjustable voltage source. The determination may be based on predefined relationship or algorithm. Said predefined relationship or algorithm may be stored in and retrieved from a storage device in communication with the controller.

The system parameter may be a measurable system characteristic, for instance pressure or temperature, that is representative of the number density in a region immediately downstream of the skimmer. Measurement of the system parameter provides a numerical value that can be used in further analysis for subsequent steps. Typically, the system parameter may be measured at a sensor in the system, which can return a numerical value (for instance, to the controller). In the present disclosure, the system parameter is representative of the number density in a region immediately downstream of the skimmer and so is related to (proportional to, or has a known relationship with) the reduced electric field.

In one example, the controller may be configured to receive a measured value of a system parameter representative of the number density in a region immediately downstream of the skimmer. The controller may then be configured to determine a magnitude of the bias voltage to be applied by the adjustable voltage source based on the measured value of the system parameter. Finally, the controller may be configured to control the adjustable voltage source to apply the bias voltage of the determined magnitude to the extraction lens, in order to control the reduced electric field in the region immediately downstream of the skimmer.

More specifically, the controller may be configured to determine the magnitude of the bias voltage to be applied by the adjustable voltage source to the extraction lens based on the measured value to maintain the reduced electric field at an approximately constant value. In other words, the magnitude of the bias voltage may be determined according to a predefined relationship between the measured value of the system parameter and the bias voltage applied, in order to maintain the reduced electric field (the ratio E/n, noted above) at an approximately constant value. An approximately constant value may be a value that is constant to within ±10%, or more preferably constant to within ±5%. The predefined relationship between the measured value of the system parameter and the bias voltage applied may be used to look to achieve a predetermined value for the reduced electric field, T (also described as the Townsend number).

Typically, the predefined relationship between the measured value and the applied bias voltage in order to maintain the reduced electric field as constant is a linear relationship. The initial extraction field applied may be determined by an optimized setting of the extraction lens voltage, to result in the highest sensitivity. The initial measured value of the system parameter (for example, pressure) can be measured for a “clean” skimmer (without build-up) and using a calibrant solution. The measured system parameter (for instance, pressure) can be measured after a few minutes of plasma operation to ensure a stabilised skimmer temperature. Therefore, the reduced electric field (or so-called Townsend number) is always the ratio of the initial extraction field strength to the initial measured value (for instance, pressure).

The system parameter may be pressure in a region immediately downstream of the skimmer. The measured value of the system parameter may be obtained via a sensor arranged in a region immediately downstream of the skimmer. For instance, this could be a sensor arranged in a chamber between the skimmer and the extraction lens.

In a particular example, the sensor is a pressure sensor and the system parameter is pressure in a region immediately downstream of the skimmer. The pressure sensor may measure a numerical value for the pressure (for instance, an instantaneous pressure) and return the numerical value to another element (such as the controller). A change in the pressure in the region immediately downstream of the skimmer may indicate a change in the number density, which could be mitigated by a change in the electric field so as to maintain a constant reduced electric field, T (or Townsend number).

In a further described example there is a torch for generating an inductively coupled plasma, the torch comprising:
a torch tube comprising a support end and an open end, wherein a portion of the open end defines a cavity for at least partially confining the inductively coupled plasma;
an injector tube comprising a bore extending through the injector tube between an injector inlet end for receiving a sample flow into the bore and an injector outlet end for conveying the sample flow out of the bore, wherein the injector tube is positioned to extend at least partially through the torch tube; and
wherein the diameter of the bore decreases between a first location and a second location, and the diameter of the bore is constant or decreases between the second location and a third location, the first location being closer to the injector inlet end than the third location, and the second location being between the first and third location in the direction of sample flow through the bore of the injector tube.

The torch is for generating a plasma, more specifically an inductively coupled plasma. The torch allows for introduction of a gaseous sample, a solution sample, a dry aerosol sample or the like into the plasma. The plasma generates gaseous and ionised particles of the sample, to be passed from the plasma towards the mass analyser.

The support end of the torch tube may be connected or held in a housing or supporting structure or supporting apparatus, whereas the open end has an opening to the bore through the torch tube. The torch tube is of greater diameter than the injector tube, so that the injector tube is arranged to be extending through at least part of the length of the cavity or bore extending through the torch tube (such that, through at least part of its length, the injector tube is concentric with the torch tube). The injector tube is positioned to extend at least partially through the torch tube so that the injector inlet end is closer to the support end of the torch end than is the injector outlet end to the support end of the torch. The injector tube may extend through the full length of the torch tube, but more preferably extends through only part of the length of the torch tube. In particular, an end portion of the torch tube may extend beyond the end of the injector tube extending therethrough. Sample flow out of the bore of the injector tube may be passed into a plasma generated in the cavity at the open end of the torch tube. The open end of the torch tube defines a cavity (or hollow, or void), wherein the opening at the open end is an aperture to the partially open cavity. In use, the cavity may contain or partially contain the plasma generated. The size of the cavity at the open end may be defined by the extent to which the injector tube extends though the torch tube.

The injector tube has a bore or hole extending therethrough. When the torch is in use, the sample may be passed through the bore of the injector tube into the plasma generated at the cavity of the torch tube. The injector tube is arranged such that the sample enters the bore of the injector tube at the injector inlet end, and may pass out of the bore of the injector tube at the injector outlet end.

The diameter of the bore of the injector tube is the size of the hole through the injector tube in a direction perpendicular to the direction of extension of the hole through the injector tube. The direct of extension can be considered an axial direction, with a direction perpendicular being the radial direction. The first, second and third locations are positions at different points along the direction of extension of the hole through the injector tube.

Advantageously, the presence of a reducing bore diameter in the injector tube in the direction of flow (which may be implemented as a tapering or conical portion of the bore) causes the sample flow through the injector tube to accelerate. This in turn causes the sample to enter a higher temperature plasma in the cavity of the torch tube (wherein ions from the plasma will be more energetic and faster moving), and the plasma may also be more focused (having a smaller diameter). As a consequence, less contamination and build up is seen in components downstream of the torch.

When the described torch is combined with the described sampling interface, provision of a more focused stream of charged particles causes the charged particles to more likely pass through an aperture at the inlet and an orifice at a skimmer unimpeded. In one example, the diameter of the bore of the injector tube at the injector outlet end may be 1.0 mm, whilst the aperture at the inlet may be 1.1 mm, and so the diameter of the beam of charged particles is such that it can pass through the inlet aperture unimpeded. This in turn helps maintain a constant pressure between the inlet and the skimmer of the described sampling interface, which consequently allows better control of the reduced electric field, according to the present disclosure, in the region immediately downstream of the skimmer. As such, the combination of the described torch and the presently disclosed sampling interface may have particular advantages.

The diameter of the bore at the second location may be no greater than 110% the diameter of the bore at the third location, or more preferably no greater than 105% the diameter of the bore at the third location. In some examples, the diameter of the bore at the second location is equal to the diameter of the bore at the third location. In particular, there is little or no reduction in the diameter of the bore between the second and third location, and this portion of the bore has a substantially constant diameter (being cylindrical in shape). This portion is closer to the injector outlet end than the wider portion of the bore. The presence of a section of the injector tube extending over a finite length and having a substantially constant diameter creates a more collimated beam of particles to be generated from the plasma, and less instability and separation of the plasma than compared to torch having an injector tube with a narrowing only at the very end of the bore (i.e., a constriction at the injector outlet only).

The diameter of the bore at the first location may be more than 200% of the diameter of the bore at the second location, may be more than 300% of the diameter of the bore at the second location, or may be more than 400% of the diameter of the bore at the second location. In other words, the diameter of the bore of the injector tube at the first location may be more than twice, more than three times, or more than four times the diameter of the bore of the injector tube at the second location. This extent of narrowing between the first and second location can be selected to create the required amount of acceleration of the sample flow through the bore of the injector tube when the torch is in use.

The third location may be at the injector outlet end of the injector tube. In other words, the section of the tube between the second location and the third location may extend from the second location to the injector outlet end.

The diameter of the bore may comprise a conical section (or tapering section) extending between the first location and the second location. A smoothly tapering region may be preferable compared to a step down in the bore diameter, so as to maintain a more laminar and less turbulent flow of the sample through the bore.

The diameter of the bore at the first location may be equal to the diameter of the bore at the injector inlet end. In other words, the bore extending from the injector inlet end and the first location may have a substantially constant diameter.

The injector tube is positioned to extend at least partially through the torch tube so as to define a channel between an outer surface of the injector tube and an inner wall of the torch tube, the channel for passage of a flow of a confining gas. In at least certain regions along the length of the torch tube, the channel is an annular channel surrounding the injector tube. The confining gas may be used for radially confining a plasma generated in (and/or in proximity to) the open end of the torch tube when the torch is in use. The confining gas may also act to cool the wall of the torch tube nearest the generated plasma when the torch is in use.

The diameter of the outer surface of the injector tube may be greater at the injector outlet end than at the injector inlet end. In other words, the outer diameter of the injector tube may increase as it approaches the open end of the torch tube. In a particular example, at portion closest to the injector outlet end, the outer surface of the injector tube may be conical or taper outwards so as to increase from a narrower outer diameter to a larger outer diameter (so that the largest outer diameter is at the injector outlet end). This may be useful to shape or direct the confining gas passing through the channel between the outer surface of the injector tube and the inner surface of the torch tube.

The diameter of the outer surface of the injector tube may have a tapering portion terminating at the injector outlet end, such that the diameter of the outer surface of the injector tube narrows in a direction extending from the injector outlet end towards the injector inlet end. Said tapering portion may extend only for a portion of the longitudinal length between the injector outlet end and the injector inlet end. In particular, the tapering portion may be a widening conical (or frustoconical) region at the outer surface of the injector tube arranged at the end of the injector tube closest to the injector outlet end (so having the widest diameter at the injector outlet end). This tapering portion acts to maintain a higher velocity of the already accelerated gas passing through the channel defined between the outer surface of the injector tube and the inner surface of the torch tube, as well as to direct the flow of the confining gas through a containing section at the open end of the torch tube.

The radial spacing between the outer surface of the injector tube and the inner wall of the torch tube may be approximately constant in a region aligned with the tapering portion of the outer surface of the injector tube. In other words, the annular channel defined between the outer surface of the injector tube and the inner wall of the torch tube may have an approximately constant radial width in a region extending in the axial direction that is aligned with the tapering portion of the outer surface of the injector tube. The spacing between the widening, conical portion (i.e. the tapering portion) of the outer surface of the injector tube and the inner surface of the torch tube can be selected so that the axial velocity of a gas passing from the support end of the torch tube towards the open end of the torch tube experiences sufficient acceleration to provide good containment of the generated inductively coupled plasma.

A bore extending through the torch tube between the support end and the open end and having the injector tube extending therethrough may comprise a tapering section, wherein the diameter of the bore extending through the torch tube increases between an entry to the tapering section and an exit to the tapering section, wherein the entry to the tapering section is closer to the support end than the exit to the tapering section. The diameter of the bore extending through the torch tube is the diameter or spacing between the inner wall of a hole or cavity though the torch tube. In other words, the torch tube bore widens at a section of its length compared to an immediately preceding section. This widening or tapering portion of the bore of the torch tube may align with the conical or tapering portion of the outer surface of the injector tube, as mentioned above. This further aids the acceleration and direction of the confining gas passing through the channel between the outer surface of the injector tube and the inner surface of the torch tube.

The whole of the tapering portion of the outer surface of the injector tube may be aligned with at least part of the tapering section of the bore extending through the torch tube. In other words, moving in the axial direction, as the diameter of the tapering portion of the outer surface of the injector tube increases as the injector outlet end is approached, then the bore extending through the torch tube also increases in diameter through at least the same axial portion. This allows the channel (being an annular channel defined between the outer surface of the injector tube and the inner wall of the torch tube for passage of the flow of a confining gas) to maintain a constant (or approximately constant) radial width. The radial width can be selected so that the axial velocity of a gas passing from the support end of the torch tube towards the open end of the torch tube experiences sufficient acceleration to provide good containment of the plasma. The tapering portion of the outer surface of the injector tube may extend along the same axial length as the tapering section of the bore extending through the torch tube, or the tapering portion of the outer surface of the injector tube may extend along a shorter axial length than the tapering section of the bore extending through the torch tube, but wherein part of the tapering section of the bore extending through the torch tube is concentric with the whole of the tapering portion of the outer surface of the injector tube.

The injector tube may be positioned to extend at least partially through the torch tube so that a containing section of the torch tube at the open end extends beyond the injector outlet end of the injector tube. The extension of the torch tube at the open end beyond the injector outlet end of the injector tube at the containing section may be more than five times the magnitude of the diameter of the injector bore at the injector outlet end, or more than seven times, or more than ten times the magnitude of the diameter of the injector bore at the injector outlet end.

The wall of the bore (being the inner wall of the torch tube) extending through the torch tube may define a cylinder or a partial cone in the containing section.

The torch may further comprise a load coil arranged around the outer surface of at least part of the torch tube in the containing section. The load coil may be wrapped around a portion of the radial length of the containing section. The load coil acts to pass a high power, high frequency electric current and, together with the other components of the torch, creates an intensive magnetic field to create a more stable and high temperature plasma. An axial distance (in other words, a distance in the axial direction of the torch tube and injector tube) between the injector outlet end of the injector tube and the closest surface of the load coil (in an axial direction) may be more than zero but less than the diameter of the of the injector bore at the injector outlet end (more specifically, less than 2 mm). An axial distance between the open end of the torch tube and the closest surface of load coil (in an axial direction) may be 3 mm or more, and/or may be more than twice, or more than three times, the diameter of the injector bore at the injector outlet end. The identified spacing between the injector outlet end and the load coil reduces plasma quenching as well as damage to the torch due to the high plasma temperatures. Moreover, the spacing between the load coil and the open end of the torch tube may further increase the plasma temperature as well as provide better collimation of the particle stream from the plasma. As such, this arrangement of the load coil may be applied to a torch even without the various other novel features specified above (such as the injector tube with reducing bore diameter) and yet still give technical advantages.

In a further example, there is a torch, as described above, arranged in proximity to an inlet of a sampling interface for use in mass spectroscopy apparatus, the torch arranged such that a quantity of particles from the inductively coupled plasma generated at the torch, when in use, passes through the inlet of the sample interface. The sampling interface may be that described above, or another sampling interface having an inlet. Here, the diameter of the bore of the injector tube of the torch at the injector outlet end may be less than the diameter of an aperture at the inlet to the sampling interface, wherein the quantity of particles received at the inlet from the torch pass through the aperture.

In another example there is a sampling interface, as described above, for use in mass spectroscopy apparatus, wherein the quantity of particles from an ion source are received at the inlet from a torch for generating an inductively coupled plasma, which may be the torch for generating an inductively coupled plasma as described above or may be another configuration of torch for generating an inductively coupled plasma. The diameter of the bore of the injector tube of the torch at the injector outlet end may be less than the diameter of an aperture at the inlet to the sampling interface, wherein the quantity of particles received at the inlet from the torch pass through the aperture.

When the described sampling interface is used in conjunction with the described torch, the benefits of each aspect combine to provide a still further reduction in the degradation of performance of the apparatus when extended spectroscopic analysis is undertaken.

In use, the inductively coupled plasma generated at the torch may generate the quantity of ionised particles received at the inlet. In use, the inductively coupled plasma may be generated within, or partially within, the containing section of the torch tube. Plasma may be generated within the containing section but extend beyond the open end of the torch tube.

The inlet of the sampling interface may comprise a sampling cone. The sampling cone, together with the skimmer, may assist to provide a differential aperture separating the plasma formed at atmosphere from the downstream mass analysers and detector(s) that may be at high vacuum (i.e., low pressure). Typically, a sampling cone is larger and less pointed than the skimmer, and typically has a larger orifice or aperture therethrough. The sampling cone generally has a central cone with a shallower angle of the central cone at the skimmer (which has a more acute angle).

As noted above, the diameter of the bore of the injector tube of the torch at the injector outlet end may be less than the diameter of an aperture at the inlet to the sample interface, wherein the quantity of particles received at the inlet from the torch pass through the aperture (preferably substantially unimpeded). Advantageously, this causes particles entrapped in the central plasma channel (of the plasma generated at the torch) to pass through the inlet unimpeded, and thereby helps avoid build-up at the aperture. In one example, the diameter of the bore of the injector tube at the injector outlet end is 1.0 mm and the diameter of the aperture at the inlet to the sampling interface is 1.1 mm. The unimpeded passage of the stream of charged particles helps maintain a constant pressure in an interface region between the inlet to the sampling interface and the skimmer. This in turn allows for better control of the reduced electric field in the region immediately downstream of the skimmer, and so an improved performance of the disclosed sampling interface.

In a still further described example, there is a method for sampling of ions in a mass spectrometer for subsequent spectroscopic analysis. Where the method mentions features that are common to the sampling interface and torch described above, the same description or characteristics of those common features also apply within the method. The method comprises:
providing a sampling interface comprising:
   an inlet for receiving a quantity of particles from an ion source, the quantity of particles including ions for spectroscopic analysis;
   a skimmer arranged downstream of the inlet, the skimmer comprising an aperture through which particles from the inlet pass;
   an extraction lens downstream of the skimmer, the extraction lens being configured for extracting ions from the particles passed through the aperture at the skimmer;
   an adjustable voltage source for applying a bias voltage to the extraction lens so as to generate an electric field in at least a region between the extraction lens and the skimmer; and
applying, using the adjustable voltage source, a bias voltage to the extraction lens, in order to control the reduced electric field in the region immediately downstream of the skimmer.

The reduced electric field may be a ratio of the electric field in at least the region between the extraction lens and the skimmer to the number density in the region immediately downstream of the skimmer.

The method may further comprise, prior to the step of applying, measuring a system parameter representative of the number density in a region immediately downstream of the skimmer to obtain a measured value of the system parameter, and determining a magnitude of the bias voltage to be applied by the adjustable voltage source based on the measured value.

The determination of the magnitude of the bias voltage to be applied to the extraction lens may be based on a predefined relationship between the bias voltage and the system parameter. The magnitude of the bias voltage may be determined so as to maintain the reduced electric field at an approximately constant value. An approximately constant value may be defined as a value constant to within ±10%, or more preferably constant to within ±5%.

The system parameter may be the pressure in a region immediately downstream of the skimmer. The value of the system parameter may be measured via a sensor (such as a pressure sensor) arranged in a region immediately downstream of the skimmer.

The method may further comprise providing a torch for generating an inductively coupled plasma, arranged such that the quantity of particles from an ion source are received at the inlet from the inductively coupled plasma generated at the torch. The torch may be the torch for generating an inductively coupled plasma as described above, or may be a torch for generating an inductively coupled plasma having another configuration.

Subsequent to the step of providing, the method may further comprise generating the quantity of particles including ions for spectroscopic analysis by generating an inductively coupled plasma at the torch.

The method may further comprise maintaining a pressure in a region between the inlet and the skimmer at an approximately constant magnitude. The region between the inlet and the skimmer may be considered the interface region, and the pressure in this region (which could be denoted the interface pressure) advantageously is maintained at an approximately constant magnitude (meaning being kept within ±10% of a predefined value). A constant pressure is maintained by configuring the components of the sampling interface and the torch so that a stream of charged particles from the plasma pass substantially unimpeded from the torch through the sampling interface (thereby also reducing build-up or clogging at the various apertures in the components of the sampling interface). There are two important factors that contribute to provision of the unimpeded flow, which are both provided by the torch as disclosed above. These factors are that (a) the plasma is more focused as a result of the decreasing diameter of the injector tube of the torch towards the injector outlet end, and (b) the stream of the charged particles released from the plasma generated at the torch is smaller than the diameter of the aperture at the inlet. As such, use of the disclosed sampling interface in combination with use of the disclosed torch shows particularly improved performance.

The sampling interface, as described above, can be arranged so as to be associable with at least one of the following mass spectrometry instrumentation: atmosphere pressure plasma ion source (low pressure or high pressure plasma ion source can be used) mass spectrometry such as ICP-MS, microwave plasma mass spectrometry (MP-MS) or glow discharge mass spectrometry (GD-MS) or optical plasma mass spectrometry (for example, laser induced plasma), gas chromatography mass spectrometry (GC-MS), liquid chromatography mass spectrometry (LC-MS), and ion chromatography mass spectrometry (IC-MS). Furthermore, other ion sources may include, without limitation, electron ionization (EI), direct analysis in real time (DART), desorption electro-spray (DESI), flowing atmospheric pressure afterglow (FAPA), low temperature plasma (LTP), dielectric barrier discharge (DBD), helium plasma ionization source (HPIS), spheric pressure photo-ionization (DAPPI), and atmospheric description ionization (ADI). The skilled reader will appreciate that these lists are not intended to be exhaustive.

In another described example, there is a mass spectrometer comprising the sample interface and/or the torch described above. Said mass spectrometer may be suitable for inductively coupled plasma-mass spectrometry.

1. A sampling interface for use in mass spectroscopy apparatus, the sampling interface being arranged to enable the sampling of ions in a mass spectrometer for subsequent spectroscopic analysis, the sampling interface comprising:
an inlet for receiving a quantity of particles from an ion source, the quantity of particles including ions for spectroscopic analysis;
a skimmer arranged downstream of the inlet, the skimmer comprising an aperture through which particles from the inlet pass;
an extraction lens arranged downstream of the skimmer, the extraction lens being configured for extracting ions from the particles passed through the aperture at the skimmer;
an adjustable voltage source for applying a bias voltage to the extraction lens so as to generate an electric field in at least a region between the extraction lens and the skimmer; and
a controller configured to:
receive a measured value of a system parameter representative of the number density in a region immediately downstream of the skimmer;
determine a magnitude of the bias voltage to be applied by the adjustable voltage source based on the measured value of the system parameter; and
control the adjustable voltage source to apply the bias voltage of the determined magnitude to the extraction lens, in order to control the reduced electric field in the region immediately downstream of the skimmer.

2. The sampling interface of claim 1, wherein the reduced electric field is a ratio of the electric field in at least the region between the extraction lens and the skimmer to the number density in the region immediately downstream of the skimmer.

3. The sampling interface of claim 1, wherein the controller is configured to determine the magnitude of the bias voltage to be applied by the adjustable voltage source based on the measured value to maintain the reduced electric field at an approximately constant value.

4. The sampling interface of claim 3, wherein an approximately constant value is constant to within ±10%, or more preferably constant to within ±5%.

5. The sampling interface of claim 1, wherein the measured value of the system parameter is measured at a sensor arranged in a region immediately downstream of the skimmer.

6. The sampling interface of claim 5, wherein the sensor is a pressure sensor and the system parameter is pressure in a region immediately downstream of the skimmer.

7. The sample interface of claim 1, wherein the inlet is configured for receiving a quantity of particles from an inductively-coupled plasma ion source.

8. The sampling interface of claim 7, further comprising a torch for generating an inductively coupled plasma, wherein the quantity of particles received at the inlet are received from a plasma generated at the torch for generating an inductively coupled plasma.

9. The sampling interface of claim 8, wherein the torch comprises:
a torch tube comprising a support end and an open end, wherein a portion of the open end defines a cavity for at least partially confining the inductively coupled plasma;
an injector tube comprising a bore extending through the injector tube between an injector inlet end for receiving a sample flow into the bore and an injector outlet end for conveying the sample flow out of the bore, wherein the injector tube is positioned to extend at least partially through the torch tube; and
wherein the diameter of the bore decreases between a first location and a second location, and the diameter of the bore is constant or decreases between the second location and a third location, the first location being closer to the injector inlet end than the third location, and the second location being between the first and third location in the direction of sample flow through the bore of the injector tube.

10. The sampling interface of claim 9, wherein the diameter of the bore of the torch at the second location is no greater than 110% the diameter of the bore of the torch at the third location.

11. The sampling interface of claim 9, wherein the diameter of the bore of the torch at the second location is equal to the diameter of the bore of the torch at the third location.

12. The sampling interface of claim 9, wherein the diameter of the bore of the torch at the first location is more than twice the diameter of the bore of the torch at the second location, and preferably is more than three times the diameter of the bore of the torch at the second location.

13. The sampling interface of claim 9, wherein the third location is at the injector outlet end of the injector tube of the torch.

14. The sampling interface of claim 9, wherein the diameter of the bore of the torch comprises a conical section extending between the first location and the second location.

15. The sampling interface of claim 9, wherein the injector tube of the torch is positioned to extend at least partially through the torch tube so as to define a channel between an outer surface of the injector tube and an inner wall of the torch tube for passage of a flow of a confining gas.

16. The sampling interface of claim 15, wherein the diameter of the outer surface of the injector tube is greater at the injector outlet end than at the injector inlet end.

17. The sampling interface of claim 9, wherein the torch has a bore extending through the torch tube between the support end and the open end and having the injector tube extending therethrough comprises a tapering section, wherein the diameter of the bore extending through the torch tube increases between an entry to the tapering section and an exit to the tapering section, wherein the entry to the tapering section is closer to the support end than the exit to the tapering section.

18. The sampling interface of claim 9, wherein the injector tube of the torch is positioned to extend at least partially through the torch tube so that a containing section of the torch tube at the open end extends beyond the injector outlet end of the injector tube.

19. The sampling interface of claim 18, wherein the wall of the bore extending through the torch tube defines a cylinder or a partial cone in the containing section.

20. The sampling interface of claim 18, wherein the torch further comprises a load coil arranged around the outer surface of at least part of the torch tube in the containing section.

21. The sampling interface of claim 20, wherein an axial distance between the injector outlet end of the injector tube and the load coil is greater than 0, and preferably less than 2 mm.

22. The sampling interface of claim 20, wherein an axial distance between the open end of the torch tube and the load coil is 3 mm or more.

23. The sampling interface of claim 9, wherein the diameter of the bore of the injector tube of the torch at the injector outlet end is less than the diameter of an aperture at the inlet to the sample interface, wherein the quantity of particles received at the inlet from the torch pass through the aperture.

24. A method for sampling of ions in a mass spectrometer for subsequent spectroscopic analysis, the method comprising:
providing a sampling interface comprising:
an inlet for receiving a quantity of particles from an ion source, the quantity of particles including ions for spectroscopic analysis;
a skimmer arranged downstream of the inlet, the skimmer comprising an aperture through which particles from the inlet pass;
an extraction lens arranged downstream of the skimmer, the extraction lens being configured for extracting ions from the particles passed through the aperture at the skimmer; and
an adjustable voltage source for applying a bias voltage to the extraction lens to generate an electric field in at least a region between the extraction lens and the skimmer;
measuring a system parameter representative of the number density in a region immediately downstream of the skimmer to obtain a measured value of the system parameter;
determining a magnitude of the bias voltage to be applied by the adjustable voltage source based on the measured value of the system parameter; and
applying, using the adjustable voltage source, to the extraction lens the bias voltage at the determined magnitude, in order to control the reduced electric field in the region immediately downstream of the skimmer.

25. The method of claim 24, wherein the reduced electric field is a ratio of the electric field in at least the region between the extraction lens and the skimmer to the number density in the region immediately downstream of the skimmer.

26. The method of claim 24, wherein the magnitude of the bias voltage is determined based on the measured value to maintain the reduced electric field at an approximately constant value.

27. The method of claim 26, wherein an approximately constant value is constant to within ±10%, or more preferably constant to within ±5%.

28. The method of claim 24, wherein the system parameter is pressure in a region immediately downstream of the skimmer.

29. The method of claim 24, wherein the sampling interface further comprises a torch for generating an inductively coupled plasma, arranged such that the quantity of particles from an ion source are received at the inlet from the inductively coupled plasma generated at the torch.

30. The method of claim 29, further comprising generating the quantity of particles including ions for spectroscopic analysis by generating an inductively coupled plasma at the torch.
